(19) United States
(12) Patent Application Publication
(10) Pub. No.: US 2003/0065941 A1
(43) Pub. Date: Apr. 3, 2003

(54) Message handling with format translation and key management

(76) Inventors: Clinton L. Ballard, Suquamish, WA (US); Joshua N. Lizon, Bremerton, WA (US); Christopher D. Ayers, Suquamish, WA (US); Daniel K. Horn, Kingston, WA (US); Ricardo L. Spates, Bremerton, WA (US); Jon G. Delmendo, Bremerton, WA (US); Joseph P. Sines, Port Orchard, WA (US); Andrew E. Olsen, Bremerton, WA (US); Timothy W. Smith, Silverdale, WA (US)

Correspondence Address: KODA LAW OFFICE, P.O. BOX 10057, BAINBRIDGE ISLAND, WA, 98110, US

(21) Appl. No.: 09/946,773

(22) Filed: Sep. 5, 2001

(51) Int. Cl. H04K 1/00

(52) U.S. Cl. 713/201; 380/277; 380/30

(57) ABSTRACT

A subscribing user generates a private key and a corresponding public key stored locally in a “key-ring.” The public key is uploaded to a key repository on a communications server, where public keys of subscribers are maintained. When sending a secure message, the sender's key-ring is checked to determine whether the public key for the recipient is present. If yes, then the public key is used to encrypt the message. If no, then a lookup request is sent to the server to determine whether a public key is available for the recipient. If there is, then the public key is downloaded from the repository to the sender. When the recipient receives the secure message, the recipient's private key is used to decrypt the message. The sender's most recent public key also is transmitted with the message and stored in the recipient's key-ring for future messages sent back to the key owner. Automated key management features are included.

### CROSS REFERENCE TO RELATED APPLICATION

This invention is related to U.S. patent application Ser. No. 09/637,467 filed Aug. 11, 2000 for “Limiting Receiver Access to Secure Read-Only Corn munications Over a Network,” U.S. patent application Ser. No. 09/878,047 filed Jun. 7, 2001 for “Dial Back E-Mail System Using Binary Protocol,” and U.S. patent application Ser. No. 09/877,916 filed Jun. 7, 2001 for “Adaptive File Transfer Acceleration.” The content of such applications are incorporated herein by reference and made a part hereof.

### BACKGROUND OF THE INVENTION

This invention relates methods and apparatus for handling and managing network-based communications, and more particularly to methods and apparatus for formatting and securing messages.

Computers and networks have been used for decades to send messages between people. Communications are routed between two individuals, from one person to many people, from many people to one, or from many people to many people. Messages are sent instantly or delayed. A popular form of messaging is e-mail. Other network-type messaging forms includes bulletin boards, mailing lists, and instant messaging.

Many methods have arisen to facilitate a large number of ways to interconnect people. In general, separate protocols have been used for the different types of communications. Even within a single type of communication, email, a large variety of different and incompatible means are used. Simply bridging the gap between two types of email systems becomes non-trivial, and crossing over from email to IM (instant messaging) is very problematic.

In addition to the different methods, a given person may have a variety of email addresses, an ICQ number, AOL IM number, fax number, and a voice mail phone number. There is a great challenge in facilitating these communications: one person many addresses, many protocols and the likelihood of additional addresses and protocols based on future ways of communicating.

In many network based communication systems, a user accesses messages by communicating with a message server and providing an address and password. However, there is very little assurance built into the communication protocols to protect against stolen passwords. Once a password is compromised, anyone in possession of the password is able to retrieve messages directly from the message server. Often, the person owning the compromised password will not be aware of the breach.

The state of the art in cryptography allows messages to be encrypted during transit and decrypted using a private key. Typically, these systems have a “pass phrase”, which is a longer form of a password that can be used to recreate the private key. Once the private key is compromised, encrypted transfers provide no protection. In order to minimize the occurrence of compromised keys, cryptographic systems require system administrators to properly administrate the creation and distribution of private keys. Current cryptographic systems are dependent on sophisticated technology professionals to setup and maintain the system of private keys. Also, because system administrators need to have access to all the information, they themselves become a primary source of a security breach. If a system administrator can be compromised, the system is compromised. This dependency on system administrators creates a large burden of having to start all over again whenever there is turnover in system administrators.

One challenge with all the various messaging methods is in providing compatibility. Consumer e-mail products often are designed to be compatible with the popular Outlook Express software from Microsoft Corporation. However, there are many people who use web-based e-mail. The way the web-based cryptography systems work is that a normal email is sent to the recipient indicating that an encrypted email is available at a specified unique URL. The user clicks on that URL and the content of the decrypted email is displayed on a web page. However, even if the secure HTTPS protocol is used, this method suffers from a fundamental flaw: anybody that intercepts the notification email can simply click on the URL to obtain the encrypted information. Another problem is that the decrypted email is only available on a web page, so it is very cumbersome to keep copies of the message organized with all the other emails received.

Many security methods require that a password or passphrase be used to protect each message, or that a password or passphrase be bound to either the sender or receiver. Such methods suffer from the general problems with passwords. Once the password is compromised, the protection is lost. Additionally, having to enter a password for every message sent or received is too burdensome on the user. Most people will quickly abandon such a procedure. So even if encryption protection is available, it may go unused due to its cumbersome nature. Even systems that provide both an Outlook plugin and a web-based interface do not solve the fundamental ease of use problem. If it is not easy to use, it will not be used by the general consumer.

### SUMMARY OF THE INVENTION

According to the invention, message handling is provided to apply transformations on outbound messages and inbound messages to enable compatibility among different network-based messaging formats and protocols. In addition message security is provided based on machine authentication. In some embodiments password protection also is provided as an additional layer of security so as to provide user authentication.

According to one aspect of the invention, messages intended for various messaging systems are merged into a single stream of inbound and outbound messages, with specific access points for a variety of transformations. An advantage of the invention is that a message coming in from one messaging system can be routed to a different messaging system, and a message sent using one system can be routed through a different messaging system. A message that uses any valid address to a recipient will be received and be stored by the client software of choice. Conventionally, the manner of message handling is determined by the sender's selection of the messaging system used to deliver the message. According to an aspect of this invention, the selection of how to process an inbound message instead shifts to the message recipient.

According to another aspect of the invention, specific access points are provided where a transformation process can be invoked. In some embodiments virus detection is performed at an access point prior to downloading an entire message. As a result, the virus can be avoided. In some embodiments, virus detection is performed at an access point prior to message transmission to detect unauthorized virus messages unknowingly being piggybacked onto a message to spread the virus. As a result, proliferation of viruses is reduced.

According to another aspect of the invention, message security is provided by key management methods. A subscribing user generates a private key and a corresponding public key on their computer. Both keys are stored on their computer in a database, refered to herein as a key-ring database. The public key also is uploaded to a key repository database on a communications management server. The key repository maintains public keys for subscribers.

When a given user (e.g., the sender) desires to send a message to another user (e.g., the recipient), the sender's key-ring database is checked to determine whether the public key for the recipient is stored on the local key-ring database. If it is, then that public key is used to encrypt the message which is sent to the recipient. If the recipient's public key is not present locally, then a lookup request is sent to the communications management server to determine whether there is a public key available for the recipient. If there is, then the public key is downloaded from the repository to the sender for use in encrypting the message to the recipient. If the recipient's public key is not present in the key repositiory, then the sender is warned that a secure message cannot be sent to the recipient. When the recipient receives the secure message, the recipient's private key stored locally on the recipient's key-ring database is used to decrypt the message.

According to another aspect of the inention, each time a sender sends a secure message to a recipient, the sender's public key is included in the header. On the receiving side, the sender's public key in the header is processed and associated with the sender's address. If the sender's public key is more recent than one that already exists on the recipient's receiving machine or if there is no public key on such machine for the sender's address, then the sender's public key is stored in the key-ring database at the recipient's machine.

According to some embodiments the message encryption and decryption is performed transparent to the end user. For example, in one embodiment the user sets a default to send all message in a secure mode (e.g., encrypted). In such case, key checking and encryption are attempted for each message.

According to another aspect of the invention, key management at the user end is facilitated automatically. When a user attempts to send a message, but has no sender's private key or sender's public key in the key-ring database, then the user is prompted to specify whether the keys are located on another machine. If so, the user is instructed to upload the keys from such other machine. Otherwise, the keys are generated and the public key uploaded to the key repository.

Similarly, when a recipient receives a secure message on a machine where the recipient's private and public key are not present, the recipient computer prompts the recipient to upload the keys. Alternatively, new keys are generated. The public key then is uploaded to the key repository, and also sent to the sender where the message is automatically resent using the new public key to encrypt the message.

These and other aspects and advantages of the invention will be better understood by reference to the following detailed description taken in conjunction with the accompanying drawings.

### BRIEF DESCRIPTION OF THE DRAWINGS

FIG. 1 is a schematic diagram of an exemplary wide area network hosting the method of this invention;

FIG. 2 is a block diagram of a computer system for a computer connected into the network of FIG. 1;

FIG. 3 is a block diagram of the wide area network of FIG. 1, including a key server configuration according to an embodiment of this invention;

FIG. 4 is a functional flow diagram of a communications management server according to one embodiment of this invention;

FIG. 5 is a functional flow diagram of client computer message services acording to an embodiment of this invetion;

FIG. 6 is a diagram of a key ring data structure for a client computer of FIG. 5;

FIG. 7 is a flow chart for a send secure message process according to an embodiment of this invention;

FIG. 8 is a flow chart for a receive secure message process according to an embodiment of this invention;

FIG. 9 is a flow chart of a send process including a message transformation according to an embodiment of this invention; and

FIG. 10 is a flow chart of a receive process including a message transformation according to an embodiment of this invention.

### DESCRIPTION OF SPECIFIC EMBODIMENTS

Host Network Environment

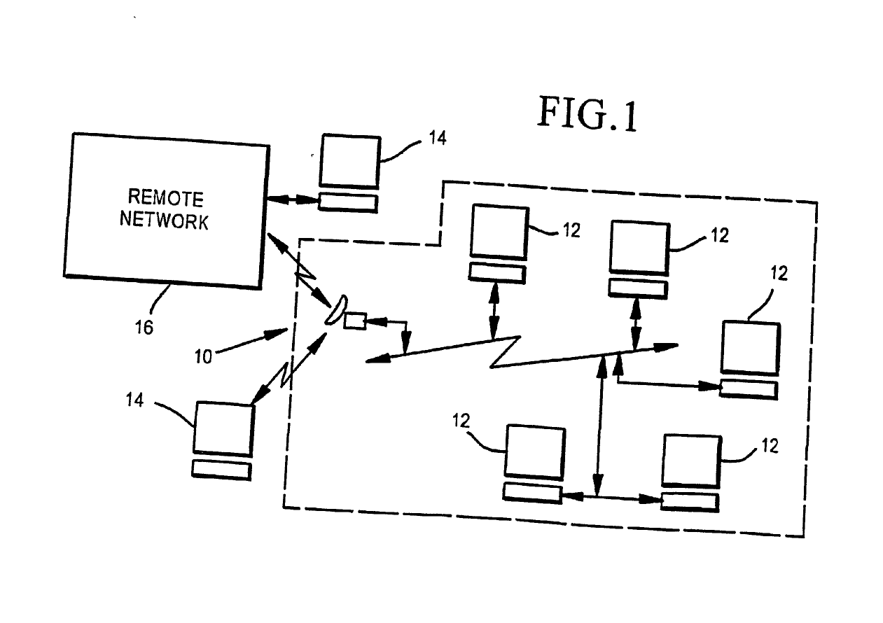

FIG. 1 shows a wide area network 10 formed by a plurality of network server computers 12 which are interlinked. Each network server computer 12 stores documents accessible to other network server computers 12 and to client computers 14 and networks 16 which link into the wide area network 10. The configuration of the wide area network 10 may change over time as client computers 14 and one or more networks 16 connect and disconnect from the network 10. For example, when a client computer 14 and a network 16 are connected with the network servers computers 12, the wide area network includes such client computer 14 and network 16. As used herein the term computer includes any device or machine capable of accepting data, applying prescribed processes to the data, and supplying results of the processes.

The wide area network 10 stores information which is accessible to the network server computers 12, remote networks 16 and client computers 14. The information is accessible as documents. The term document as used herein, includes files (as per the Windows operating system usage), documents (as per the MacOS operating system usage), pages (as per the web phraseology usage), and other records, entries or terminology used to describe a unit of a data base, a unit of a file system or a unit of another data collection type, whether or not such units are related or relational.

The network server computers 12 are formed by main frame computers minicomputers, and/or microcomputers having one or more processors each. The server computers 12 are linked together by wired and/or wireless transfer media, such as conductive wire, fiber optic cable, and/or microwave transmission media, satellite transmission media or other conductive, optic or electromagnetic wave transmission media. The client computers 14 access a network server computer 12 by a similar wired or a wireless transfer medium. For example, a client computer 14 may link into the wide area network 10 using a modem and the standard telephone communication network. Alternative carrier systems such as cable and satellite communication systems also may be used to link into the wide area network 10. Still other private or time-shared carrier systems may be used. In one embodiment the wide area network is a global information network, such as the Internet. In another embodiment the wide area network is a private intranet using similar protocols as the Internet, but with added security measures and restricted access controls. In still other embodiments the wide area network is a private, or semi-private network using proprietary communication protocols. In some embodiments various communication protocols are supported, including one or more email formats, document formatss, voice formats, and facsimile formats.

The client computer 14 is any end user computer, and may also be a mainframe computer, minicomputer or microcomputer having one or more microprocessors. The remote network 16 may be a local area network, a network added into the wide area network through an independent service provider (ISP) for the Internet, or another group of computers interconnected by wired or wireless transfer media having a configuration which is either fixed or changing over time. Client computers 14 may link into and access the wide area network 10 independently or through a remote network 16.

Computer System

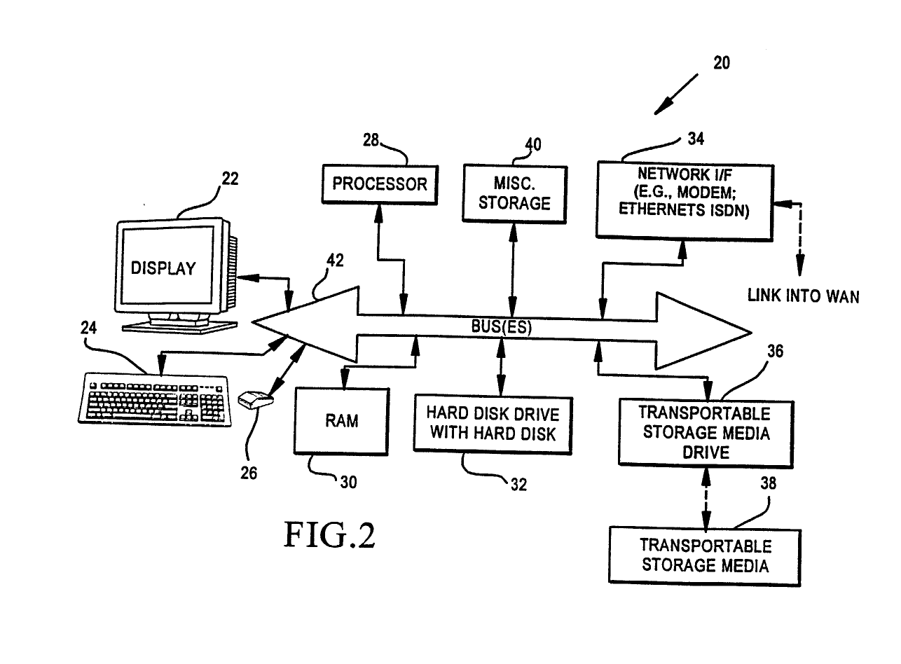

The functions of the present invention preferably are performed by programmed digital computers of the type which are well known in the art, an example of which is shown in FIG. 2. A computer system 20 has a display monitor 22, a keyboard 24, a pointing/clicking device 26, a processor 28, random access memory (RAM) 30, a non-volatile storage device such as a hard disk drive 32, a communication or network interface 34 (e.g., modem; ethernet adapter), and a transportable storage media drive 36 which reads transportable storage media 38. In addition other miscellaneous storage devices 40, such as a floppy disk drive, CD-ROM drive, zip drive, bernoulli drive or other magnetic, optical or other storage media, may be included. The various components interface and exchange data and commands through one or more busses 42. The computer system 20 receives information by entry through the keyboard 24, pointing/clicking device 26, the network interface 34 or another input device or input port. The computer system 20 may be any of the types well known in the art, such as a mainframe computer, minicomputer, or microcomputer and may serve as a network server computer 12, remote network 16 computer or a client computer 14. The computer system 20 may even be configured as a workstation, personal computer, network server, a reduced-feature network terminal device, facsimile machine, or voice messaging machine. The computer 20 also may include peripherals such as a fax machine or microphone. In some embodiments the computer 20 is a server for a local area network.

Communications Management Server

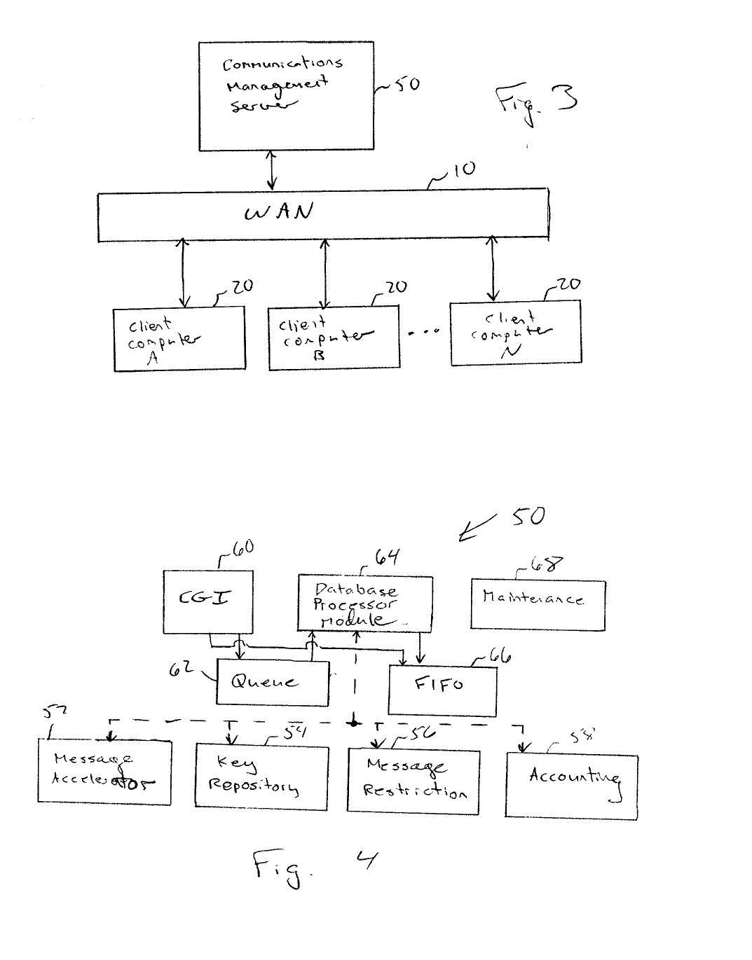

Referring to FIG. 3, the wide area network 10′ is configured to include a communications management server 50 which is accessed by client computers 20. The communications management server 50 includes several modules as shown in FIG. 4. In one embodiment the server 50 is part of a subscriber management system in which subscribers to a service access the server 50 to accomplish subscriber allowed actions. For example, the server 50 is used in a preferred embodiment for managaing keys in a secure messaging service. In other embodiments, additional services, such as accelerated messaging, restricted messaging, subscriber software upgrading is achieved through the server 50. Account information also is available through the server in some embodiments. The accelerated messaging features are described in U.S. patent application Ser. No. 09/877,916 filed Jun. 7, 2001 for “Adaptive File Transfer Acceleration.” The restricted messaging features are described in U.S. patent application Ser. No. 09/637,467 filed Aug. 11, 2000 for “Limiting Receiver Access to Secure Read-Only Communications Over a Network.” The content of such applications are incorporated herein by reference and made a part hereof.

In a preferred embodiment the server 50 includes executable code and at least a key repository database 54. Client computers 20 access the server 50 to request that a specific action be taken, such as to update local information stored on the client computer 20. In some embodiments, verification is performed with each access to assure that the user making the request has authorization for the action requested. Exemplary requests include: verify account status, validate user, update account information locally, upload or download keys for encryptng messages to other users, upgrade local software modules stored on the client computer 20, and inform the accounting module that a user's account status has changed.

The key repository 54 serves as a key server for secure communications. The key repository 54 stores individual public keys which are used for encrypting messages. The keys are indexed in one embodiment by a user address (e.g., e-mail address) and are used whenever a sender of a secure message does not already have a recipient's public key stored on the sender's client computer 20 key-ring.

Additional data bases include a message accelerator 52 which serves to compress e-mail messages. A message restriction data base 56 includes similar repository features of the key repository 54, and also additional features for securing and restircting message access on a message by message basis. This enables restrictions to be placed on the message such as a self-destruct time and a number of downloads permissible. Messages sent using this message restriction scheme are both secure and locked. A key is stored for decrypting the message. However, whether a receiver can unlock the message depends on the restrictions stored for that message (as set by the sender).

An accounting database 58 tracks accounting data for member users, including account and user limitations. Before sending a secure message, a user registers to become a subscriber (also referred to herein as a member). In some embodiment there is another database included for responding to user requests for client computer software upgrade information.

Each client computer 20 accessing the communications management server 50 includes a key-ring database. The key-ring includes a private key and an associated public key for a specific user address. Other public keys are stored on the key-ring corresponding to subscriber users to whom communications are sent or received.

Referring again to FIG. 4, the server 50 includes a CGI module 60 that serves as an interface for receiving requests from a client computer 20. In one embodiment the content of the request is posted into a file within a queue directory 62. The queue 62 serves as a structure for intercommunication between the CGI 60 and a database processing module 64. The data base processor module 64 handles the requests received from the client computers 20. When new requests are detected in the Queue directory 62, the database processing module 64 creates a list of requests that it found and moves this list into a processing area. It then executes pre-defined actions based on each desired request in sequence. As each request is completed, the response that was generated from it is written to a corresponding FIFO 66 set up by the CGI 60. The FIFO 66 then is read by the CGI 60 and transmitted back to the client computer 20 which originated the request.

The server 50 also includes maintenance scripts 68 for keeping each database up-to-date and accurate. These scripts include, for example, disk maintenance, automatic credit updating, statistical information, account maintenance, log archiving and rotation, and purging of old data.

In one embodiment, when the CGI 60 receives a valid request from client computer 20 software, the module 60 creates a FIFO 66 in a PIPE directory in the same tree that it is running in. It then opens and locks a file with the same name as the FIFO in the Queue directory 62 that is also in the same tree. The contents of the request are then written to this file in the Queue directory, and the lock on the file is released, allowing the database processor modules 64 to handle the request.

If an errors occur, such as timeouts or inability to write to the file in the Queue directory, the CGI module 60 creates a special file in the Queue directory with a ‘.err’ extension. This type of file serves as a flag to the database processor 64 that there has been an error, and to ignore and delete the corresponding FIFO 66 and corresponding Queue file 62 with the same name as the ‘.err’ file.

After the CGI module 60 either gets a response from the database processor 64 via the FIFO 66, or errors occur, the module 60 writes the results to STDOUT, which is sent to the client computer 20. The CGI module 60 then deletes the corresponding FIFO 66 and exits, leaving the client computer software to terminate the connection with the server 50.

In one embodiment, the database processor 64 runs continuously in an idle loop until it detects that there is a file in the Queue directory. The module 64 then creates a list of valid files by first testing to see if file locks can be attained, then by using the error detection as described above. The filenames on this list are moved into a separate processing area, where each file is opened and processed sequentially.

The processing starts by first opening up the file and reading the first line of the request. Each specific request has a distinguishing header line that tells the database processor 64 which type it is. If this header line cannot be understood, an error is reported into a log file and an error response is written to the correlating FIFO. The next request, if any, is then opened and processed.

If the header is understood as a valid request, the rest of the input data is read and stored in memory in one master hash array, with the keys being either tag data in the header or a predetermined label of the block data. This hash array is reset each time a new request process starts. The request then goes through the appropriate logic for the type of header that was detected.

Each specific request type goes through pre-determined logic to perform the desired response. The general steps that requests go through are:

Determine what database to connect to and make the connection.

Use the input that was collected from the request in performing actions, such as database reads or writes, file operations, or any other action that is required.

Generate a response depending on the results of the actions and the format that is expected by the client.

Write the response to the FIFO that corresponds with the Queue file that was read initially.

After these steps are completed for a given request, the database processor module 64 moves onto the next request. If there are none remaining, it falls back into an idle loop, waiting for more requests to arrive.

Following are exemplary requests relating to the key repository, the message restriction and the accounting databases:

Key Repository 54 Requests:

(1) ADD-PGP-KEY—Index a key for a specific user into the key repository 54. This request is performed by the client after receiving a Token from a REQUEST-TEM-TOKEN request.

Format: <--ADD-PGP-KEY-->

EMA=<Veloz user email address>
PWD=<Veloz user Password>
PD=<Veloz Product ID>
GUID=<Machine_ID>
TKN=<TEM Validation Token>
IDS=<TEM Local Request ID>
<<<BEGIN TEM KEY BLOCK>>>
<KEY_DATA>
<<<END TEM KEY BLOCK>>>

The key repository 54 is queried for a token that corresponds to the last token that was sent to the user. The repository token is compared with the TKN value and if they do not match, return a request status indicating that the token key is invalid. If the tokens match, the <KEY_DATA> is inserted into the key repository database 54, replacing any key that was there before for this user's email address. In some embodiments accounting also is performed to determine whether the user is still an active member.

Response Format

RET=<Request Status>
<Accounting Data>

2. LOOKUP-PGP-KEY - Lookup a user's key.
Format: <--LOOKUP-PGP-KEY-->

EMA=<Veloz user email address>
KID=<Email of key to look up>

The key repository 54 is queried for a key correlating with the KID email address. If one is found, the key is returned.

Response Format:

RET=<Request Status>
<<<BEGIN TEM KEY BLOCK>>>
<KEY_DATA>
<<<END TEM KEY BLOCK>>>

3. REQUEST-TEM-TOKEN - Request a token email be sent to a

specific user for validation.

Format: <--REQUEST-TEM-TOKEN-->

EMA=<User email address>
IDS=<TEM Local Request ID>

The key repository 54 is queried to determine whether a token has already been generated for the email address. If one is found, and it hasn't been requested yet, it is returned. If a token is not found or has been requested previously, a new token is generated randomly and inserted into the Tokens table for the user's email address. An email then is sent to the user with the prepared token value in a special X-eacceleration header, to verify the identity of someone for a transaction such as adding a user key.

Response Format:

RET=<Request Status>

Message Restriction 56 Requests:

1. ADD-EMC-KEY - Index an eMC key for a specific eMC message

into the message restriction database.

Request format: <--ADD-EMC-KEY-->

MID=<eMC Message ID>
NRC=<Number of Global Recipients>
TTL=<Time To Live(in seconds from now)>
NVW=<Number of Local Views>
EMB=<Embargo Time(in seconds from now)>
NEM=<Expire Notification (0=off; 1=on)>
EMA=<user email address>
PWD=<user Password>
PID=<Product ID>
GUIID=<Machine_ID>
<<<BEGIN EMAIL RECIPIENT LIST>>>
<Recipient Email List>
<<<END EMAIL RECIPIENT LIST>>>
<<<BEGIN EMC KEY BLOCK>>>
<KEY_DATA>
<<<END EMC KEY BLOCK>>>

The message restriction database 56 is queried to see if the message has already been indexed. If it has, the restrictions are updated with the new values. If it hasn't a key is inserted into a correct keys table and the restrictions are added to a correct restrictions table. In some embodiments accounting also is performed to determine whether the user is still an active member.

Response Format:

RET=<Request Status>
<Accounting Data>

2. LOOKUP-EMC-KEY - Lookup an eMC key for a specific eMC
message.
Request format: <--LOOKUP-EMC-KEY-->

MID=<eMC Message ID>
EMA=<user email address>

A query is performed into the message restriction database 56 for the Message ID. If a key is found, then the restrictions for the key are returned. If the key has not expired, then the key to use to decrypt the message.

Response Format:

RET=<Request Status>
NRC=<Number of Global Recipients>
TTL=<Time To Live(in seconds from now)>
NVW=<Number of Local Views>
EMB=<Embargo Time(in seconds from now)>
<<<BEGIN EMC KEY BLOCK>>>
<KEY_DATA>
<<<END EMC KEY BLOCK>>>

Accounting 58 Requests:

1. LOOKUP-ACCOUNT-INFO - Lookup accounting information for
a user.
Request format: <--LOOKUP-ACCOUNT-INFO-->

EMA =<user email address>
PWD=<user Password>
PID=<Product ID>
GUID=<Machine_ID>

Using the Email and password of the user, validation is executed to determine whether the user information is set up in the Accounting database 58 and that the password matches the user's password. If the email and password are valid, the current data for the account that the user is on is extracted from the database and formatted into a response that the client-side GUI can use.

Response Format:

RET=<Request Status>
ST0=<Text description of Account Type>
ST1=<Credits String 0>
ST2=<Credits String 1>
ACT=<Account Type>
LC0=<Low Credits 0>
LC1=<Low Credits 1>

All of the values are stored locally in the client, and used to display the correct account information to the user. The RET return status can be set to 1 to denote that the user did not have enough credits for the particular transaction they had tried to do. By monitoring this value, the client knows when to prompt the user with things such as ‘out of credits’ and ‘Invalid password’ dialogues inside the GUT.

The LC# tags are used to let the user know that they are running low on credits. The response values are:

LC#=

0=Credits Available

1=Credits are low, but not zero

2=Credits are zero

2. SEND-USER-PASSWORD—Send an email with a forgotten password to the user's email address.

Request format: <--SEND-USER-PASSWORD-->

EMA=<user email address>

The Accounting database 58 is queried to determine whether the email address given is indexed currently. If a match is found, an email is sent to this email address with the user's password in an X-eAcceleration header, as well as the body of the message, in descriptive text.

Response Format:

RET=<Request Status>

Message Accelerator 57 Request: (AEM MailServer)

1. ADD-ACCELERATOR-EMAIL—Index an AEM message into the AEM MailServer and return the URL's to upload the message to.

Request format:

<--ADD-ACCELERATED-EMAIL-->
MID=<AEM Message ID>
FSZ=<Size of Message(in Bytes)>
EMA=<Sender Email>
PWD=<Sender Password>
GUID=<Machine ID>
PID=<Product ID>
<<<BEGIN EMAIL RECIPIENT LIST>>>
<Recipient Email Addresses>
<<<END EMAIL RECIPIENT LIST>>>

Check to see if striping is possible using predefined criteria and input parameters such as file size. Perform a lookup for the Message ID in the AEM MailServer. If the message as already been indexed, return the results of the lookup and do *not* debit credits from the account. If striping is possible, calculate how many stripes to use based on the file size. Index the message into the AEM MailServer DB. This is done by choosing the upload location with the most resources available. The physical locations on the disk are separated into two main locations, one for free trial users and one for paid users. Debit the user's account based on the number of kB the message is taking up on the disk. If accounting was successful, return the URL's to upload and download from, multiple URL's if striping is enabled.

| | |
|---|---|
| Response Format: | STR=<Striping Enabled?(0=no;1=yes)> |
| | RET=<Return Status> |
| | #Striping Disabled |
| | URL=<Upload URL> |
| | DURL=<Download URL> |
| | FSZ=<Size of Message(in Bytes)> |
| | #Striping Enabled |
| | ULST#=<Upload URL (Striping)> |
| | DLST#=<Download URL (Striping)> |
| | FZST#=<Size of Stripe> |
| | <Accounting Data> |

2. LOOKUP-ACCELERATED-EMAIL—Lookup the location of an indexed AEM message and return the URL's to download the message from.

Request format:

<—LOOKUP-ACCELERATED-EMAL—>

MID=<AEM Message ID>

EMA=<Recipient Email>

PWD=<Recipient Password>

GUID=<Machine ID>

PID=<Product ID>

URC=<Use Recipient Credits(0=no; 1=yes)>

Performs query for the specified Message ID in the MailServer. Accounting checks are done on the sender's account, unless the recipient has informed the client that they want to use their own credits. This is useful for times when the recipient wishes to download the message, but the sender has ran out of credits. The URC Tag is set to 1 in this case.

If the message is found, and the desired account has enough credits, return the download and upload URL's. Multiple URL's are returned in the case where striping was enabled on the sender's side.

Response Format:

STR=<Striping Enabled? (0=no; 1=yes)>

RET=<Return Status>

#Striping Disabled

URL=<Upload URL>

DURL=<Download URL>

FSZ=<Size of Message(in Bytes)>

#Striping Enabled

ULST#=<Upload URL (Striping)>

DLST#=<Download URL (Striping)>

FZST#=<Size of Stripe>

<Accounting Data>

Message Accelerator 57 Requests cont'd): (AEM POPServer)

1. CHECK-ACCELERATED-EMAIL—Check to see if there are any messages indexed in the AEM POPServer and return a list of message ID's to lookup via the LOOKUP-ACCELERATED-EMAIL request.

Request format:

<—CHECK-ACCELERATED-EMAIL—>

EMA=<Veloz user email address>

Check the AEM POPServer for message_ID's belonging to the user.

Response Format:

RET=<Request Status>

<<<BEGIN AEM MSG_ID BLOCK>>>

MSG_ID

MSG_ID

. . .

<<<END AEM MSG_ID BLOCK>>>

These MSG_ID's are ones that are already indexed into the AEM MailServer and POPServer.

2. CHECK-POP-EMAIL—Used by the Client to check a user's POP Email on an external POP server.

Request format:

<—CHECK-POP-EMAIL—>

EMA=<Veloz user email address>

PWD=<Veloz user password>

PID=<Veloz Product ID>

GUID=<Machine_ID>

POPUSR0=<POP0 User>

POPSRV0=<POP0 Server>

POPPWD0=<POP0 Password>

POPSZL0=<POP0 Lower message size limit>

POPSZU0=<POP0 Upper message size limit>

POPUSR1=<POP1 User>

POPSRV1=<POP1 Server>

POPPWD1=<POP1 Password>

POPSZL1=<POP1 Lower message size limit>

POPSZU1=<POP1 Upper message size limit>

Check each POP account in sequence and get a list of UIDL's of the messages found for the POP user which fall between the threshold defined by the POPSZL0 and POPSZU0 Lower and Upper message size limits.

Response Format:

RET=<Request Status>

POPRET0=<POP Request Status>

POPRET1=<POP Request Status>

<<<BEGIN POP0 UIDL BLOCK>>>

UIDL

UIDL

. . .

<<<END POP0 UIDL BLOCK>>>

<<<BEGIN POP1 UIDL BLOCK>>>

UIDL

UIDL

. . .

<<<END POP1 UIDL BLOCK>>>

<Accounting Data>

The POP Request Status indicates whether the attempt to log into the POP server was a success or failure. The return value codes are:

POPRET=

0=Success

1=Host unreachable

2=Login Failure

A failure might look something like this:

RET=0

POPRET0=1

POPRET1=0

<<<BEGIN POP0 UIDL BLOCK>>>

<<<END POP0 UIDL BLOCK>>>

<<<BEGIN POP1 UIDL BLOCK>>>

UIDL

UIDL

. . .

<<<END POP1 UIDL BLOCK>>>

<Accounting Data>

In this case, POPRET0=1, which means that the POP0 host was unreachable.

3. GET-POP-EMAIL—Used by the client to tell the server to download a list of MDG_ID's from an external POP server(s) and index it into the AEM system.

Request format:

<—GET-POP-EMAIL—>

EMA=<Veloz user email address>

PWD=<Veloz user Password>

PID=<Veloz Product ID>

GUID=<Machine_ID>

POPUSR0=<POP0 user>

POPSRV0=<POP0 Server>

POPPWD0=<POP0 Password>

POPUSR1=<POP1 user>

POPSRV1=<POP1 Server>

POPPWD1=<POP1 Password>

<<<BEGIN POP0 UIDL BLOCK>>>

UIDL

UIDL

. . .

<<END POP0 UIDL BLOCK>>>

<<<BEGIN POP1 UIDL BLOCK>>>

UIDL

UIDL

. . .

<<<END POP1 UIDL BLOCK>>>

Perform the following tasks:

Verify connection with each POP Server is available

Append a line to a POP_QUEUE file for each POP request.

Format is (all in one line):

EMA=user@domain.com POPUSR=joes POPSRV=webcelerator.org

POPPWD=password UIDLS=xxxxx yyyyy . . .

The UIDL's would be used as AEM MSG_ID's to index the messages into the AEM MailServer and POPServer. This allows the client to compare them against what has already been downloaded. An external process monitors the POP_QUEUE file. It downloads the messages, compress them, add them into the AEM MailServer and then into the AEM POPServer. Upon the next CHECK-ACCELERATED-EMAIL request, the messages that were indexed here are also be returned.

Response Format:

RET=<Request Status>

POPRET0=<POP Request Status>

POPRET1=<POP Request Status>

<Accounting Data>

Using the same definitions of error codes described in CHECK-POP-EMAIL

4. DELETE-ACCELERATED-EMAIL—Used to delete an AEM message from the POPServer and possibly the MailServer.

Request format:

<—DELETE-ACCELERATED-EMAIL—>

EMA=<Veloz user email address>

PWD=<Veloz user Password>

PID=<Veloz Product ID>

GUID=<Machine_ID>

<<<BEGIN AEM MSG_ID BLOCK>>>

MSG_ID

MSG_ID

. . .

<<<END AEM MSG_ID BLOCK>>>

Delete the entry out of the AEM POPServer DB, and if this is the last entry for that message, also mark the message in the AEM MailServer to be purged by a maintenance script. This command would be used when the client detects that a MSG_ID that it received from the CHECK-POP-EMAIL request has already been downloaded successfully. This greatly reduces old messages cluttering up the database and disk space after they have been downloaded by all of the recipients.

Response Format:

RET=<Request Status>

<Accounting Data>

Database Structures

In an exemplary embodiment, the following tables and fields used in the databases

Message Accelerator Database 57 (AEM=Accelerated e-mail):

(1) AEM Mailserver—Stores indexing and path information for AEM messages. Also keeps track of system resources such as disk usage and file locations available.

Resource Fields: information on system resources

Path_Index

Partition_Name

Dir_Path

FTP_Path

HTTP_Path

Block_Size

Blocks_Avail

Files_Avail

Max_Subfiles

Active

Member

Location Fields: Path index information for the indexed messages

Loc_Index

Path_Index

Dir_Index

Files_Used

Messages_# Fields: Array of tables that store the message ID's and the Location Index where they are stored

MSG_Index

Loc_Index

MSG_ID

Email_Sender

Filesize

Added_TS

Received

(2) AEM POPServer—Database for message ID lookups based on the message ID's stored in the AEM MailServer. This provides a way for the client to query if there are any messages left on the MailServer for a given user.

Table Structure:

POP_#: Array of tables that store the user and Message ID's for that user.

Fields:

POP_Index

MSG_ID

Recipient_Email

Stripes

Message Restriction Database 56 (eMC KeyServer)

Storage for eMC message keys. These keys are used to decrypt messages that were locked using eMC. The restrictions for acquiring each key are also stored here.

Table Structure:

Keys_#—Array of tables that store the message ID, the sender's email address, and the correlating eMC key

Fields:

DB_Index

MSG_ID

Email

Data

Update_TS

Restrictions_#

Array of tables that store the message ID and what restrictions the sender has chosen to put on the availability of the stored key

Fields:

DB_Index

Expire_Timestamp

Expire_Views

Embargo_Timestamp

Num_Recipients

Dead_Notice

Key Repository 54: (TEM KeyServer)

Storage of individual Public Keys to use when encrypting email sent that is locked using TEM. These keys are indexed by email address and used whenever a sender of a TEM email does not have the recipient's public key stored on their local machine.

Table Structure:

Keys_#—Array of tables that store the user's email address and their current Public Key.

Fields:

Email

Data

Update_TS

Tokens

Temporary Storage of Tokens used to validate the identity of users before adding or replacing their Public Key

Fields:

IDS

Email

Token

Used

Added_TS

Upgrade Info Database:

Stores update/upgrade information about specific modules in ‘update-enabled’ products. Queries to this database will result in the return of URL's where the updates are available for download.

Table Structure:

Versions:—Holds all data required to provide accurate URL's to download needed updates

Fields:

Version_Index

Weight

Module_ID

Current_Version

HTTP_Path

FTP_Path

Download_Mode

Updated

Active

Accounting Database 58:

Holds all accounting information for users that are set up via the client upon first contact with the system, or through an online sign up/purchase of credits. Each account may contain multiple users, and is not limited to any particular pricing structure, since pricing plan information is not stored here. This database is used for granting or denying a request to use the services based on their credits available, subscription expiration date, account status, password validation, and MAX machine limit.

The Accounting Databases are actually split up into two separate databases. One holds static information such as account initialization settings, and the other holds the actual account information that is updated as the users purchase or use credits.

(1) Static Accounting Information

Table Structure:

Init_Index—Provides Initialization based on any string match on any field in the Initialization data. For example: Init domain X using specific account settings.

Fields:

What_To_Look_At

What_To_Look_For

Precedence

Init_Pricing_ID

init_type_string_id

Low_Credit_Warning Index

Stores what level of credits to report that the user is running low on credits.

fields:

pricing_id

service_id

low_credit_warning_level

Pricing_Index

Describes what Paid/Free status an account is set to.

fields:

pricing_id

description

Pricing_Init_Index

Holds the credits to initialize to for a new account.

fields:

pricing_id

init_service_id

init_free_credits

init_paid_credits

Product_Index

Provides description of product ID's

fields:

product_id

description

Service_Conversion_Index

Holds code to use when converting credits to display strings to use in the GUI. This provides the ability to convert raw credits to MB, days, etc in any language.

fields:

service_id

pricing_id

credit_to_display_conversion_Perl

credit_to_display_conversion_PHP

price_to_display_conversion_Perl

price_to_display_conversion_php

Service_Index

Description of different service ID's.

fields:

service_id

description

Type_String_Index

Holds the description of the type of account the user is using(ie: Personal, Advanced, Corporate). Also holds the corresponding maximum number of machines that type of account can install the product on.

fields:

type_string_id

description

max_guids

(2) Dynamic Accounting Information

Table Structure:

Account_Credits_Remaining_{—}1

Service_ID 1 (Usage) Credits remaining. Also holds the date to refresh the account automatically and number of credits to refresh to.

Fields:

Account_ID

Free_Credits_Remaining

Paid_Credits_Remaining

Refresh_Date datetime

Refresh_Credits

Account_Credits_Remaining_{—}2

Service_ID 2 (Days) Credits remaining. Also holds the date to refresh the account automatically and number of credits to refresh to.

Fields:

Account_ID

Free_Credits Remaining

Paid_Credits_Remaining

Refresh_Date datetime

Refresh_Credits

Account_Index

Core information about the account. The user ID of the Account Holder (Main user that set up the Account), account settings indexes, and the timestamp when the account was last updated. Also provides Account Status, so a bad account can be disabled for any reason.

Fields:

Account_ID

Main_User_ID

Pricing_ID

Type_String_ID

Update_TS

Account_Status

GUID_Index

Holds the GUIDs (Machine IDs) that are being used by an Account.

Fields:

GUID

Account_ID

User_Credits_Used_{—}1

Amount of lifetime Usage credits used per user.

Fields:

User_ID

Free_Credits_Used

Paid_Credits_Used

User_Index

User specific information, such as password (encrypted) and email address.

Fields:

User_ID

Email_Address

Account_ID

Password

Client Computer Secure Message Handling

There are a variety of methods for user authentication that require various levels of additional effort on the encryption and/or decryption end. To gain acceptance, however, it is desirable that encrypted messaging procedures be identical to unencrypted transmissions, or at most involve clicking to enable or disable encryption. This simplicity of use goes directly counter to the user authentication requirements. But encryption that is cumbersome to use, oftentimes does not get used, so a transparent way of encrypting that might not have quite as high a level of user authentication that gets used, is better than a method of encryption that provides 100% user identification and maximum security, but does not get used.

In a preferred embodiment, machine authentication is employed, rather than user authentication, so as to ease the user requirements. A password also is included in some embodiments as an added layer of user authentication for multiple users on the same machine. Realistically, if someone gains physical access to a machine, any amount of sabotage is possible, from planting of a snooping program to physically removing the hard drive. If the physical security of a computer cannot be assured, then any amount of user authentication provides merely a false sense of security. The advantage of assuming that a machine will be physically secure is that usual methods of guarding physical property will also safeguard the electronic messages.

Using standard public key cryptographic systems, it is possible to generate a secret key using random and irreproducible inputs, like the number of microseconds from the time the machine was restarted, to generate a private key that is kept secure on a specific machine. This key is bound to a specific address and the matched public key is registered with the key repository 54. Since the key generation and propagation is a highly complex process that requires computer knowledgeable personnel to maintain, a new problem of making sure that the entire system of private and public keys maintains accuracy is a non-trivial problem to be solved. Since the intended audience are non-technical end users, it is preferable that confusion concerning the proper keys be automatically detected, along with a method of correction.

For example, a lot of people use the same address on more than one computer, which creates the problem of getting the same secret key associated with the address on each computer that it is used on. This in turn creates the possibility of inadvertently creating a new secret key that is associated with the same address on a different machine. Once two different keys get associated with the same address, some machines will be using the correct public key, but others will be using the obsolete public key, because when a new private key is created, a matching public key is created and that one is to be stored in the key repository 54 so that encrypted messages can be sent.

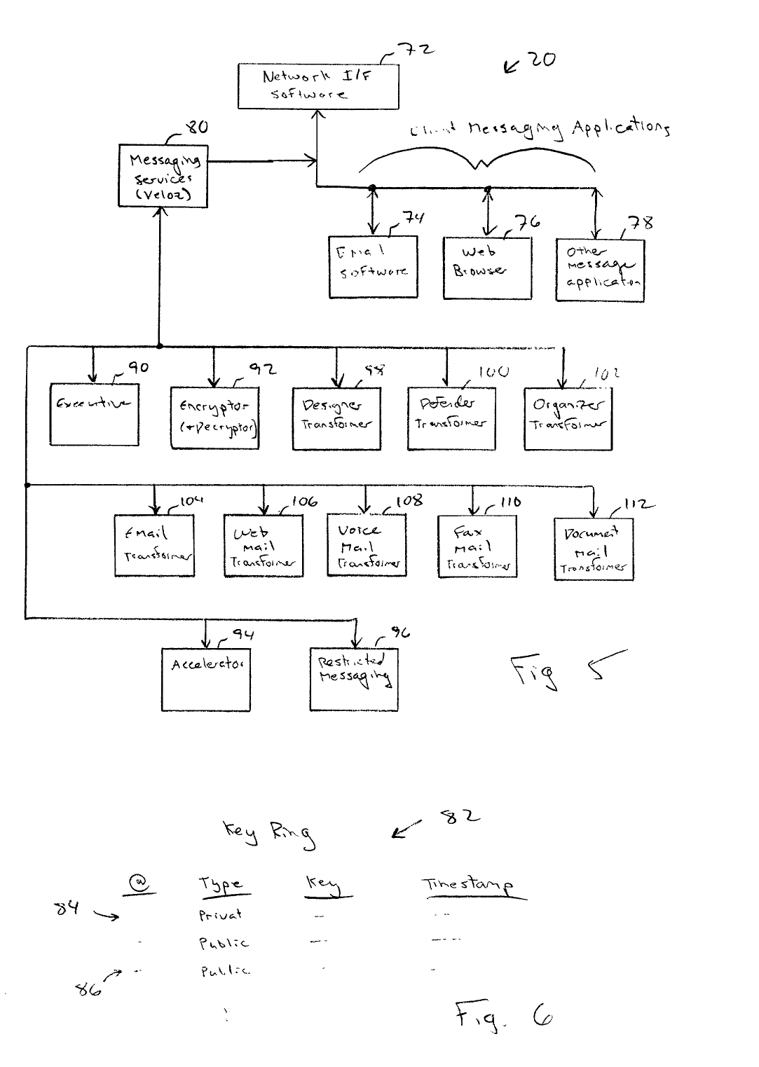

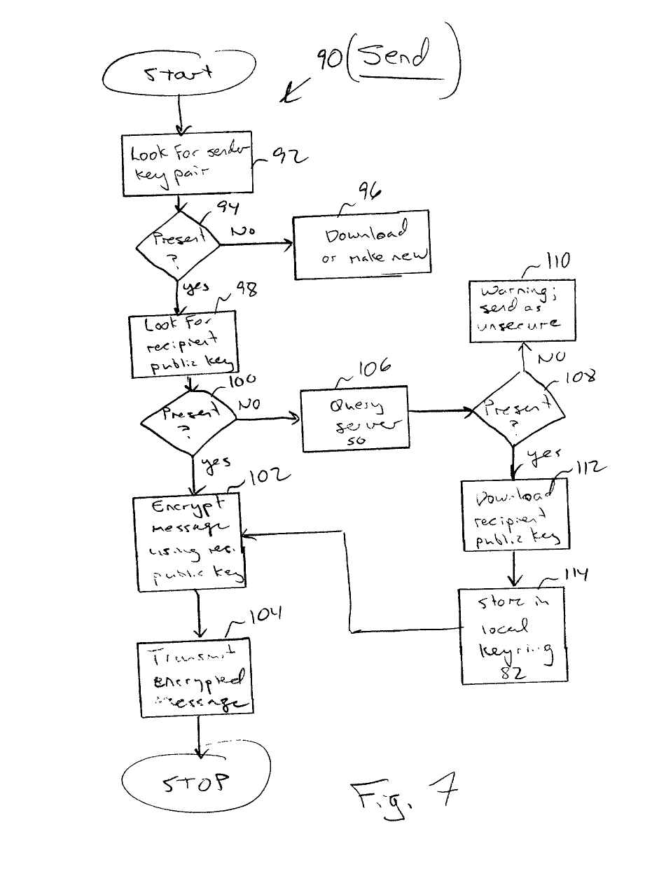

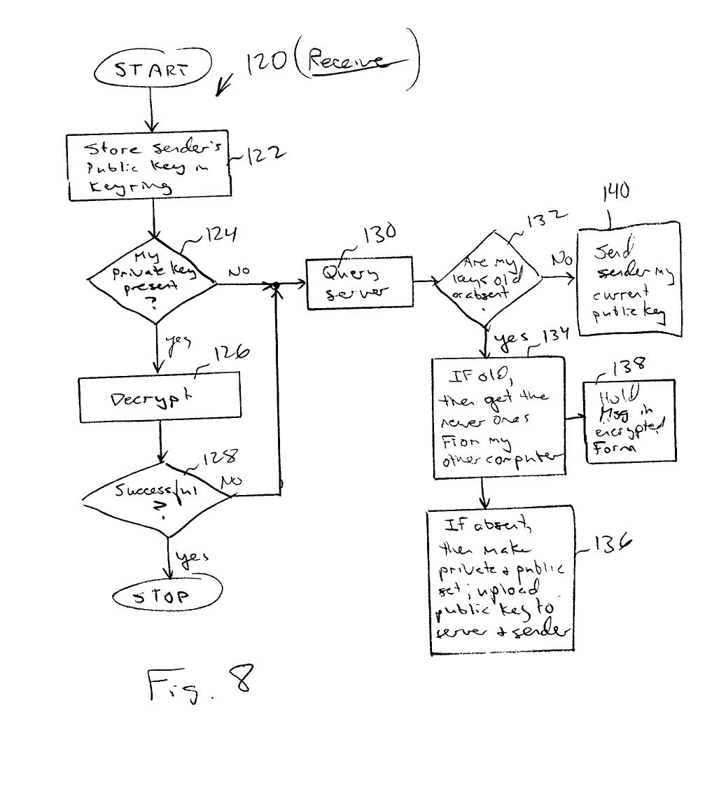

Referring to FIG. 5, the computer 20 is configured to support network communications through network interface software 72 and one or more client messaging applications (e.g., communication applications) 74-78. For example, conventional modem or other network interface software 72, including network interface protocol drivers, is used. Exemplary client messaging applications include email software 74, a world wide web browser 76 and/or another messaging application 78 (e.g., voice mail messaging; fax messaging). In addition, a messaging services program 80 is included for supporting subscriber services. The messaging services program includes an executive 90, and various modules 92-112. An encryptor module 92 is included for handing secure messaging. An accelerator module 94 is included in some embodiments for performaing accelerated e-mail messaging. A restricted messaging module 96 is incuded in some embodiments for limiting recipient access to a specific message. In addition one or more transformer modules 98-112 are included in various embodiments to provide additional services. A designer transformer 98 is included for designing the look of a message. A defender transformer 100 is included for defending against viruses. An organizer transformer 102 is including for organizing a data base of messages. Various conversion transformers are including for changing the form of a message being sent or received. An email transformer 104 is accessed to change the message format to a specific email protocol. A web mail transformer 106 is accessed to change the form of a message to a web-based protocol. A voice mail transformer 108 is included for changing the format of a message to a voice mail. A fax mail transformer 110 is included for changing the format of a message to a fax transmission. A document mail transformer 112 is accessed to change the format of a message to a specific doument type (e.g., word processing; graphics).

In operation the messages services program 80 intercepts messages from the messaging applications 74-78 at specific access points to implement default modes of the additional services (e.g., message security, message acceleration, message restriction). Alternatively, the messaging services program 80 generates dialogs and confirmations of subscriber message service activities.

Secure Messaging

With regard to secure messaging the computer 20 includes a key-ring databse 82 set up by the messaging sevices program 80. A subscribing user generates a private key 84 and a corresponding public key 86 which are stored on the key-ring 82. The public key 86 also is uploaded to the key repository database 54 on a communications management server 50. The key repository 54 maintains public keys for subscribers. The local key-ring 82 also stores public keys 88 for others according to user address. Each secure subscriber message sent over the network includes the public key of the sender in a header or other known portion of the message. Every time a subscriber message is received on the computer 20, the sender's public key in the received message is extracted to determine whether there is already a public key in the local key-ring 82 for that sender address. If not, the sender's public key 88 is stored in the recipient's key-ring 82. If there already is a public key for that sender adress which differs, then the new key is overwritten into the key-ring 82.

Every time a sender desires to send a secure subscriber message to a recipient, the executive program determines whether there is a public key in the local key-ring 82 for that recipient address. If the recipients public key is in the key-ring 82, then that public key is used to encrypt the message which is sent to the recipient. If the recipient's public key is not present locally, then a lookup request (LOOKUP-PGP-KEY) is sent to the communications management server 50 to determine whether there is a public key available for the recipient. If there is, then the public key is downloaded from the repository 54 to the sender computer 20 for use in encrypting the message to the recipient. The recipient's public key also is stored in the sender's key-ring 82. If the recipient's public key is not present in the key repositiory 54, then the sender is warned that a secure message cannot be sent to the recipient. When the recipient receives the secure message, the recipient's private key stored locally on the recipient's key-ring database is used to decrypt the message.

When encryption is enabled, the messaging services software 80 resident to the client computer 20, automatically encrypts outgoing email messages whenever possible. If a message cannot be encrypted, the sender is prompted to inquire what should be done. Alternatively, the user may choose default options that are in use for this case. When secure messages are received, the secure messaging software at the receiving computer 20 automatically decrypts the messages. If a message cannot be decrypted, the cause is detected based on the error handling cases described below in a separate section.

The secure messaging software performs several functions, including: checking for existing keys and detecting invalid keys. The server 50 is used to assist in key validation and automatic propagation of public keys. Whenever a user attempts to create or send an encrypted message, the secure messaging software checks to see if the user has a valid set of keys for their current email address. If they do not, then the secure messaging software (e.g., referred to as the Encryptor) checks to see if the user is to import keys or create new ones. It gets this information by asking the user whether or not they are using the secure messaging software on another computer with the same email address.

If they are using the address on another computer, then preferably they are to export their keys from the other computer and import them to the new computer. As soon as the Encryptor detects that a user needs to import, it stores that information and informs the user that they need to import anytime that they attempt to enable encrypted messaging again. It continues to do this until the user imports keys (or attempts to import keys.)

If the user does not need to import keys, then the Encryptor creates new keys for their address immediately, and then uploads the new public key to the key server 50. In the case where a user already has been enabled and begins using a new email address, the Encryptor detects such condition when the user attempt to send an encrypted message. The encryptor prompts to find out if the user needs to create new keys or import keys. If the user needs to import keys, the Encryptor checks to make sure that the user has actually imported valid keys for the sending address. If they have not then the user cannot use the Encryptor until they do. If the user is to create keys, the keys are created immediately and then uploaded to the key repository 54 on server 50.

With regard to detection of invalid keys, the following occurs for a send or receive operation. Whenever a user attempts to send a secure message, the Encryptor checks to make sure that the user has keys for their email address and then it checks to make sure that the user's public and private keys are a matched pair. If they are not, then it makes sure that the user either imports valid keys or creates new keys.

When a user receives a message that cannot be decrypted, the encryptor immediately checks the timestamp of the user's keys and the timestamp of the public 110 key for that address that is stored in the key repository 54 on the server 50. It then compares the timestamp of the key(s) on the user's machine against the timestamp of the key in the repository 54 and the timestamp of the key that was used to encrypt the message. If the Timestamp of the user's key is older than either of the other keys, then the key is considered invalid and the user is prompted to either import their valid key if needed, or a new one is created for their address.

If the user's key is newer than the one used to encrypt the message and newer than the key on the server (it may also match the key on the server and be newer than the key used to encrypt the message.) For these cases the user's key is valid so they are informed that the message was encrypted with an old key and then the Encryptor automatically sends the user's valid public key back to the sender who had the old key. When this key is received on the other end, it is automatically imported onto the user's key-ring to replace the old key.

Use of the key repository for key validation and automatic propagation:

The key repository 54 is used to store the public keys for all users accessing the secure messaging software. Whenever a user sends a secure message to someone for the first time, the Encryptor checks the key repository 54 for the recipient's key. If the key is found, it is downloaded automatically and added to the sender's key-ring. Anytime that the secure messaging software on a client computer creates a new key for a user, the new key is uploaded to the key repository 54. If there is an old key already in the key repository 54 for that user, then it get's replaced with the new key. This way the newest key is the only one that gets distributed from the server 50. The keys on the server are also used for comparison, when the Encryptor attempts to determine whether or not a user's keys are valid. If the keys on a user's computer are older than the key stored on the server then the Encryptor knows that the user's keys are invalid.

In addition to using the key repository 54 for propagation, each time a veloz user, who has already gone through the key generation or importing process, sends an email, will automatically appends the public key to the header of the email. If the recipient of the email is a veloz user, the key is automatically taken from the header and placed in the veloz key-ring. If the recipient is not yet a veloz member and the message was sent with a transformer enabled, the recipient will receive the message as a .vlz attachment. After installing veloz, the user can then click on the .vlz attachment and the message will be processed, at which time the key is copied from the header of the email to the new veloz user's key-ring.

The secure messaging software gives the user several options for importing and exporting keys without having any knowledge about how keys work. One place the user can take advantage of this feature is on the Encryptor tab in a settings panel. In some embodiments the option is also available by right clicking either on the toolbar or task tray icon for veloz. The user chooses one of two options, import or export. If the user chooses import, an “import key from file” dialog is shown. In one embodiment the dialog is similar to the standard windows “save as” dialog. The user navigates to the location of the key file they wish to import and selects “open”. There are three possible choices for the type of key file to be imported: public(*.pub), secret(*.sec), or all keys(*.tem). The veloz software automatically finds and places the imported keys into the user's key-ring.

Choosing export causes display of a “Save Exported Key As . . . ” dialog. Again this dialog is based upon the standard windows “save as.” dialog. To export their veloz keys, the user chooses where to save the keys and whether to export their public, secret, or all veloz keys on the machine. To choose the destination in one embodiment, the user navigates to the location and chooses a filename. The type of key can be chosen from a dropdown menu. The choice for “all keys” export the user's public and secret keys, along with any other public veloz keys that they have accumulated on their key-ring. This eliminates the need for having to re-seed the new computer they import the keys onto, and can begin sending encrypted mail to those recipients immediately.

Error Handling

When a sender desires to transmit a secure message, the normal case is for the sender computer to already have a private key and public key stored locally on its key-ring. In addition the public key also is stored in the key repository database 54 of the communications management server 50. However, there are several potential error cases that may arise as follows:

1) no public key, no private key, no key on server.

2) no public key, no private key, public key on server.

3) no public key, have private key, no key on server.

4) no public key, have private key, public key on server.

5) have public key, no private key, no key on server.

6) have public key, no private key, public key on server.

7) have public key, have private key, no key on server.

8) have public key, have private key, public key on server.

9) have public key, have private key, mismatched key on server.

10)have public key, have mismatched private key, have public key on server that matches pub key on machine.

11)have public key, have mismatched private key, have public key on server that matches sec key on the machine.

12)have public key, have mismatched private key, no key on server.

13) Have your own public and private keys

14) have your own private key, but no public key

15)no public key, no private key

16)have public key, no private key

17)have public key, mismatched private key

18)you make new keys, someone sends you a message using an old key

19)you make new keys, send to someone who has your old key

Following are procedures for handling the error conditions according to an exemplary embodiment. The settings.dll and the rescue dialogues referred to below are part of the database processor module 64. The veloz.exe program is part of the client computer 20 software for implementing the secured communication processes described herein.

Cases 1-6 and 10-12:

A first error condition procedure is for handling error cases 1 to 6 and 10 to 12, each being handled in the same manner.

SEND: When a user tries to send the first TEM email, a script (e.g. settings.dll) detects that there is not a valid key pair for that email address. The script calls a TEM rescue dialog which determine whether to import or create new keys based on whether the user has that email address in use on another machine. If the user needs to import then they will be given the opportunity to do so. If they choose to wait till later, then TEM will be disabled until they import. If they do not need to import, then settings.dll will generate new keys for that address.

After going through these steps, settings.dll will check again whether the user now has a valid key pair, (This is mostly to catch the case of a fake or invalid import). If the user still does not have a valid key pair, then settings.dll will disable TEM, and prevent it from being re-enabled until a key pair exists.

If settings.dll does not detect the missing/invalid keys, then an executive module for the communication scheme (e.g., veloz.exe) resident to the client computer will detect the problem as soon as it attempts to send the email. It will call the TEM rescue dialogues to find out if the user needs to import. If the user does not need to import, then veloz.exe will make new keys for that user.

RECEIVE: When a user receives a TEM message that cannot be decrypted, veloz.exe running locally on the client computer calls settings.dll at the server 50 and passes in the timestamp data for all of the related keys on the user's machine and the timestamp data for all of the keys used to encrypt the message. The time stamps for the keys used to encrypt the message are taken from the header information of the message. The server 50 also accesses the timestamp data for all of the related keys on the server 50. Settings.dll will check the timestamps of the message keys against the timestamps of the keys on the user's machine.

As soon as the setting.dll script it finds that one or both of the keys on the machine are missing or the keys are mis-matched, settings.dll will then call TEM rescue dialogues to find out if the user needs to import or create new keys. If the user needs to import, they will be given the opportunity to do so. After importing they will be given the chance to have Veloz automatically try again to decrypt the message. If they choose to import later, then TEM will be disabled until the import. If they do not need to import then settings.dll will find out what email address they need to create new keys for and then it will pass that information back to veloz.exe and veloz.exe will create new keys for the user.

Cases 7-9:

A second error condition procedure is for handling error cases 7 to 9, each being handled in the same manner.

SEND: None of these cases can be detected during sending.

RECEIVE: When a user receives a TEM message and it cannot be decrypted, veloz.exe calls settings.dll and passes in the timestamp data for all of the keys used to encrypt the message along with the timestamp data for all of the related keys on the user's machine and the timestamp data for all of the related keys on the TEM server. Settings.dll checks the timestamps of the message keys against the timestamps of the keys on the user's machine.

For keys on the client computer 20 have an older timestamp than the message key or the server key, the keys are invalid. As soon as settings.dll finds that the machine key pair is older than the server key or the message key the TEM rescue dialogues is called to find out if the user needs to import or create new keys. If the user needs to import, they are given the opportunity to do so. After importing they are given the chance to have Veloz automatically try again to decrypt the message. If the user chooses to import later, then secure messaging is disabled until the import. If they do not need to import then settings.dll finds out the email address for which new keys are to be created. Then it passes the information back to veloz.exe and veloz.exe creates new keys for the user.

For keys on the client computer 20 have a newer timestamp than the server key and the message key, the keys are valid. Settings.dll brings up a dialog letting the user know that they have received a message encrypted with an old key. Then Veloz.exe automatically sends the valid public key back to the original sender of the message, so that future messages are be encrypted with the correct key (Veloz.exe automatically intercepts the key and replace the old key with the new one). Veloz.exe also uploads the valid key to the server, if it is not already there.

Case 18:

For case 18, where a user makes new keys, and someone sends them a message using an old key, another error procedure is executed. Settings.dll brings up a dialog letting the user know that they have received a message encrypted with an old key. Then Veloz.exe automatically sends the valid public key back to the original sender of the message, so that future messages are encrypted with the correct key (Veloz.exe automatically intercept the key on the other end and replace the old key with the new one.). Veloz also uploads the valid key to the server, if it is not already there.

Case 19:

For case 19, where a user makes new keys and sends a message to someone who has the old key, veloz.exe at the receiving end will automatically replace the old key on the key-ring with new key.

Server 50 down error cases:

For case 13 (Have your own public and private keys)

SEND: The user has the recipient's public key—no server contact is needed, so just send encrypted message with public key on local machine. Where the local client computer 20 does not have the recipient's public key, in one embodiment veloz.exe checks the server for the key if it has not checked before. If the server is down, the message is not encrypted. Confirmation shows that the message for the specified recipient could not be locked. Note that if the server check fails, veloz.exe does not count this as the one check for that email address, which would cause it not to check again.

RECEIVE: Where the keys on machine match the key used to encrypt message, no server contact is needed, just decrypt the message. Where the keys on machine do not match the key used to encrypt message, veloz checks with the server 50 for timestamps of keys used to encrypt. If the server is down, the case is treats as if there are no keys on the server. The timestamps on the machine are compared to the keys in the message. If the keys on the machine are valid, no server contact is required. The valid key is automatically mailed back to sender. If the key on the machine is older than the key used to encrypt the message, the rescue dialogues are invoked. The user is prompted to import the keys. The key then is uploaded later.

Cases 14-17:

Each of error cases 14 to 17 are dealt with in the same manner. If the user is missing any keys or they are mismatched, it is treated as if they have no keys.

SEND: Sender has the recipient's public key. The user rescue dialogues are invoked and the user either imports or creates, whatever the case they choose is. The message is encrypted with recipients key and appends the new local public key if possible. The new public key is sent to server 50 later.

If there is no key for the recipient, then the user rescue dialogues are invoked. Confirmation displays “cannot lock message for—”. A newly created or imported public key is appended to unencrypted message. The new public key is sent to server 50 later.

RECEIVE: Normally veloz.exe checks the server for timestamps of keys used to encrypt. If the server is down, then veloz.exe treats the case it as if there are no keys on the server. The timestamps on the machine are compared to the keys in the message. Since there is no valid key pair, the user rescue dialogues are displayed. The user either imports or creates new keys. The key is uploaded to the server 50 later.

Detection and handling of the server down cases by client computer (Veloz.exe):

For any of these cases, Veloz.exe first checks the server 50 and makes sure that it is working before attempting to: download public keys for recipients; upload new public keys; or download and check the timestamps of keys on the server. If it finds that the server is down, then the following cases are processed:

1. Downloading public keys: Veloz.exe treats this case as if there was no key on the server for the recipient. This event is not counted as the “one” check for the key for this email address.

2. Uploading new public keys: For this action, Veloz.exe just waits until a later time and then checks the server again performing the upload once the server is up and running again.

3. Checking timestamps of keys on the server: For this action, Veloz.exe treat this as if there were no key on the server for that address.

Secure Message Send Overview

Referring to FIG. 7 a flow chart 90 is shown for a send process executed by the messaging services processor 80 of the client computer 20. At step 92, the local key-ring 82 is checked to see if there is a valid key pair stored for the sender on this computer. If not (step 94), then at step 96 the user downloads the missing private and or public key from another computer used by the user which stores such keys. Alternatively, new keys are generated.

At step 98, the key-ring 82 is tested to determine whether there is a public key stored locally for a desired recipient to whom the user is to send a secure message. If present (step 100), then at step 102, a message is encrypted using the public key associated with the recipient. At step 104, the encrypted message is transmitted over the network 10 to a user address of the recipient associated with the public key.

If at step 100 the recipient's public key is not stored locally in the key-ring 82, then at step 106 the communications management server 50 is queried to look-up a public key for the recipient's address. If a public key is not present on the server 50 (step 108), then at step 110 the message is sent to the recipient in an unencrypted format, or alternatively the sender in some embodiments is given the option of not sending the message at that time. If the recipient's key is present (step 108) in the key repository 54 on the server 50, then at step 112 it is downloaded to the sender computer, and at step 114 is stored in the local key-ring 82. The message then is encrypted at step 102 and transmitted at step 104.

Secure Message Receive Overview

Referring to FIG. 7, flow chart 120 is shown for a receive process executed by the messaging services processor 80 of the client computer 20. At step 122, the sender's public key is extracted from the header and entered into the recipient's key-ring 82. At step 124 the key-ring is checked to determine whether the recipient's keys are present on this computer. If they are, then the message is decrypted using the private key of the recipient. at step 126. If the decryption is successful (step 128), the receipt is complete. If the decryption is unsuccessful or the private key is not present, and in some embodiments in all cases before decryption is attempted, the server 50 is queried at step 130 to determine whether there are valid keys for the recipient. (e.g., Are the keys absent? Are the key an old set? Is the subscriber's account expired?) If the keys are old, then at step 134 the recipient is informed to download their newer keys from wherever the user has such keys stored. The message is held in encrypted form at step 138 and decrypted once the current keys are loaded onto the recipient's current computer. If the recipient's keys are absent and the account is active, then the recipient generates a set of keys and sends the public key to the key repository 54 and sender at step 136. If the server indicates that the recipient's keys are current, then the sender must have an old public key. At step 140, the current public key of the recipient is transmitted to the sender computer. The sender computer automatically re-encrypts the message with the new public key and sends the message to the recipient once again.

Message Access Points and Transformer Operations

To properly encrypt outbound messages, the message is intercepted at prior to being sent over the wide area network. To properly decrypt inbound messages, the message is intercepted before being received by an email client appliction or web browser application. In various operating systems, there are a variety of ways to intercept email data. One approach is to have a plugin or equivalent for each email client to be supported that gets access to the outbound and inbound flow of emails. In a preferred embodiment a lower level network protocol interception method is used which allows monitoring of all network traffic for POP and SMTP protocols. The primary protocol used to send email is SMTP and the primary protocol to receive email is POP3. An advantage of the lower level interception method, is that an HTTP protocol transmission can also be intercepted. In still another embodiment an even lower level method of interception a special network driver is used. In such embodiment the TCP/IP protocol stack is modified to utilize the special driver. The special driver, intercepts the packet data and passes the encrypted, decrypted and/or transformed data on to the actual hardware within computer 20. Accordingly, interception can happen at any of various data flow levels. Interecption at any specific level has a different set of issues, but fundamentally, at any level messages are identifed and diverted to the transformer module in a standardized form of header, body and attachment. The header, body and attachment are then transformed and then sent through after being processed. On the receiving end, the message is split into the header, body and attachment and reverse transformed and then fed into the appropriate email client or web browser.

Of significance is that non-email messaging protocols also are intercepted and converted into a header, body and attachment format and sent to the transformer module. On the receiving end the reverse also is done. Any messaging system in which the message can be intercepted prior to transmission and formatted into a header, body and attachment format potentially is able to be handled by the transformer. Similarly, the reverse ability to input a header, body and attachment, is used on the rceeiving end for conversion to a form of the recipient's choice. In some scenarios input is received from one type of messaging system and diverted to another type of messaging system.

For example, web mail systems are not suited for handling a large number of emails. It is desirable to divert received web emails into a standard email client that would have folders and mail filters already setup, rather than deliver just the web page address. In some embodiments a more functional Viewer interface is provided that allows for more operations than a web mail page. Contents of the message are displayed in such a Viewer instead of sending it to the web page. It also is possible to send the message to multiple destinations, because once the ability to interface to a different messaging system is established, they are all equivalent.

The transformer methodology allows messages of different messaging systems to be merged into a universal Inbox. Different addresses within a single messaging system also can be routed to the same Inbox. It is desirable to organize inbound emails by a variety of characteristics and the specific address used is one of those.

In a specific embodiment an LSP is used to to intercept low level network protocol traffic and the POP3, SMTP and HTTP protocols are monitored and intercepted when appropriate. In practice, the various web mail systems are subject to constant change and such changes potentially could disable the proper functioning of the above. To rapidly respond to changes in the web mail systems, a self-updating mechanism is implemented which determines when a new version of a module is available. This version change information is piggybacked onto other commands that are being made anyway, so there is no additional transaction overhead to communicate the latest version information to all the clients. When a new version is detected to be available, it is fetched and updated. This self-updating process allows quick changes to the running version of the software to correct any problems or the addition of new features. In the event that errors are being generated by the software and there have been no recent transactions with the server, a special request is made to obtain the latest version information.

Primary Access Points

Contrary to what might seem to be a simple issue of intercepting traffic on the inbound path and outbound path comprising the only two access points, there are several additional access points used to implement a general message transformation system. Additionally, the order of processing is significant. To illustrate all the different access points, it is instructive to go through the entire life cycle of an email from creation to reception.

1. Composing the email. Typically a simple word processor level functionality program is used to compose the email. While the most powerful transformations are done after the message is composed, some transformations change the actual process of composing the email and just as easily could replace the primary email client. However, the most value is created by being able to enhance existing software that people are already using.

2. The moment of Sending. At some point, the user will instruct their email client to actually send the email. This is a critical moment in time, as it is quite possible that default parameters need to be changed. The email client brings up a confirmation dialog. This provides the first major access point of intercepting the outbound message and provides an opportunity to post-process the email after the email client has already “sent it”. In reality, the data is intercepted and routed to the confirmation dialog to obtain specific instructions on how to process the email.

The user has the ability to set general rules on when a confirmation is even necessary and for a particular email, there might not be a confirmation. One example of a conditional confirmation is in the email accelerator where there is a size threshold of when to invoke the accelerator. For emails that are bigger than that threshold, the default is to have the accelerator active, for emails that are smaller, the default is to have the accelerator inactive. Of course, the user can override this from the confirmation dialog. By setting the default behavior for different size ranges, it is possible for the end user to eliminate the need for confirmation of each and every message. An example is to configure emails below the smallest threshold to be disabled and without confirmation. The next range of sizes defaults to disabled, but has a confirmation. The next size up defaults to enabled, but has a confirmation and the largest sizes have it enabled without confirmation. A typical size range is to have 64 KB be the first threshold, 256 KB the second and 1 MB the final threshold. In one example emails over 1 MB always activate the Accelerator, emails less than 64 KB never activate the Accelerator and ones in between go through a confirmation with the default either on or off depending on the size being over 256 KB or not.

The Encryptor 80 by contrast has less flexibility in the ability to be activated or not. Since the public key of the recipient is needed to be able to activate the Encryptor, it is quite possible that the option to enable it cannot be presented to the end user during the confirmation. However, even though encryption is possible, it might be desired to disable it, so the user can provide input to that effect during the confirmation dialog. Additionally, in the event that the security concerns are paramount, the actual sending of the email might be aborted in case encryption cannot be enabled.

In general, for a particular transformer a decision is made on whether to be active or not during the confirmation process. The default behavior is determined by global settings (which can also be changed at any time) and such behavior is specific enough to identify specific types of messages to ALWAYS be transformed or NEVER to be transformed, or to be defaulted to ACTIVE or INACTIVE, but require user input. Additionally, a transformer also can BLOCK an email from going out and the user can also decide to cancel sending. For a specific message, each transformer is passed pointers to the header/body/attachment(s) and returns one of the codes. If any of them return BLOCK, the email is prevented from going out and the user is notified of this or not depending on the global settings. If any of them return ACTIVE or INACTIVE, a confirmation dialog is displayed with the default values of all transformers displayed. If the specific transformer returned ALWAYS or NEVER, then that setting is not editable, but if it returned ACTIVE or INACTIVE, it would be changeable by the end user. There is an additional code of INACTIVE2, which is similar to INACTIVE, but instructs the display engine to not even display the active/inactive status unless the user is in advanced mode, which displays all options. This allows the practical handling of a larger number of transformers without having to display all possible options to users who do not want to be inundated with a large number of options. In some embodiments there also is a global setting on whether the user wants to treat INACTIVE as INACTIVE2 on a transformer by transformer basis. This provides a finer grain control on limiting the information that is asked of the user, without losing the power of being able to specify every aspect of every transformer for every email. The INACTIVE vs. INACTIVE2 issue is optional and only relates to the usability issues of reducing user confusion.

There are a variety of transformations that can be invoked at the moment of sending, such as spell checking, graphics overlays and other content changing processes. Once the message is finalized, there is another set of transformations such as encryption, acceleration, termination that also happen. Traditionally, the burden of figuring out what order to do these transformations in has been given to the end user. However, once beyond the question of “to spell or to not spell check”, it becomes a lot more complex and the likelihood of the end user properly ordering the transformations becomes smaller and smaller with each additional transformer. It is hard enough for the user to provide feedback on which transformers are active for each email. Some transformers affect the content, others affect the accessibility, some require user input for the transformation, others have no such requirement.

In some embodiments the processing order is hard-coded, being preset in the lab to achieve an order that works efficiently. To avoid limiting the addition of transmformers, a method to categorize and prioritize transformers is used. Each transformer includes a set of attributes that specify the type of transformation it is. An executive routine uses this to dynamically determine the order of processing. In some embodiments this information also is used to establish the processing order for the case where all transformers are active and then during the confirmation process use that as a guide to determine the order, simply skipping over the ones that are not there.

In one embodiment the key access points on the send side are VIRUSBLOCK, RAWSOURCE, MORECONTENT, SENDLOG, ENCRYPTION, and COMPRESSION, and RAWOUTPUT. There is a corresponding set of access points on the receive side that is the inverse order: PRERECEIVE, RAWINPUT, DECOMPRESSION, DECRYPTION, RECEIVELOG, CONTENTFILTER, VIRUSBLOCK, RAWDESTINATION. The PRERECEIVE on the receive side is a way to process emails BEFORE they are downloaded to the client machine. On slow connection machines, this is a very important timesaver and if there is no need to download the message in the first place, that can be determined by PRERECEIVE Transformers.

The order of invoking each transformer is based on the above order. In the event that there are no more than one in any access point, there is no complexity, the email is processed in order. In the event that there are more than one in a particular access point, each Transformer in queried as to the effectiveness it will have for the email. The actual email is presented to each transfomer, which returns a code used to rank the effectiveness of each one against each other. An EXCLUSIVE flag is also returned that indicates that a Transformer is to be the only one at this access point. Other flags that could be returned are FIRST or LAST. Unless EXCLUSIVE is returned by a transfomer in FIRST (or LAST), it will be assumed that there can be multiple Transformers within FIRST (and LAST). In the event that it is not possible to satisfy all Transformers, tiebreak criteria are used to determine the Transformer that is used. The tiebreak formula is based on user editable priorities of the entire list of transformers.

The different attributes are determined on a message by message basis, allowing dramatic efficiencies to be gained by determining this information. In most cases, the extra overhead of doing the computations for each message does not warrant it, but as CPU speeds keep increasing, it becomes feasible to do for larger and larger messages. For example, it is quite possible that a particular compression algorithm would not work as well as an alternate one for a particular file. During the bidding process, each compression algorithm estimates the likely compression level based on the email header information, which includes file type information. Thus, an audio compression engine is able to compress a .WAV file much better than a lossless compression algorithm. Of course, the user needs to allow for lossy compression on such files to be used. Instead of just estimating the compression that would be achieved, each compression engine is able to actually do the compression and provide the actual compressed file size. There is an ACTUAL flag that is passed in during the bidding process to let the transformer know whether to provide an estimated result or the actual result. Also note that any transformer can send an ABORT message to stop the transmission and based on the user configuration, the user might or might not be notified. This is most commonly used by the VIRUSBLOCK level, but it could be used by any level.

The VIRUSBLOCK access point on the send side is the earliest point that Veloz 80 intercepts the message being sent. The basic information about the email, including headers/body/attachments, and information about the process sending the email is input into all access points. Each transformer is able to use the information of the message that it needs. In the preferred embodiment the information is transmitted from one level to the next level with the then current information as each transformation is done. Alternatively, all the information at each stage is made available to all transformers. One transformer module (defender) connects to both VIRUSBLOCK access points and also to the PRERECEIVE access point. See the detailed description of Defender to understand these access points better. On the send side, alternate messaging systems feed the content from that messaging system to the VIRUSBLOCK access point. Non-text messages are converted to text at this point, so if the alternate messaging system has a voice message, a voice recognition program would convert it into text. This allows outbound telephone calls to be converted into any message format that is fully supported.

The RAWSOURCE access point is the starting point of a virus free email that has been sent by the user. A transformer module (Organizer) copies data from this access point into its database to create a complete record of all emails that are sent. It also connects to the RAWDESTINATION access point on the receive side to add all incoming emails into its database. The order of VIRUSBLOCK is slightly different on both the send side and receive side to ensure that only virus free emails are added to the database. Organizer therefore keeps track of all emails (messages) that the user sends and receives. Implicitly there is the mechanism after RAWDESTINATION that feeds into the interface for each messaging system, so incoming emails can be sent to a fax number, speech generator, etc. The format of information at the RAWDESTINATION level is the basic message itself. The interface module to each message reception would perform the appropriate conversions and send it onto the appropriate module. See below for more detail on all the non-email messaging systems interfacing to RAWDESTINATION. The overview is that the alternate messaging systems receive messages in each messaging systems format and feeds the data into the VIRUSFILTER access point on the receive side after converting it into header/body/attachment format. The interface module into each alternate messaging system then also connects to the RAWDESTINATION access point with a LAST flag.

The MORECONTENT access point is used by transformers, such as Designer, to enhance or augment the original emails. This is a good place for a spell checker or any other transformer that will affect the words in the message to connect to with a FIRST flag. After all the text processing is done, a Transformer like Designer connects to the LAST portion of MORECONTENT. Designer then allows the user to overlay graphics, add special effects, etc. and basically finalize the appearance of the email that will be sent. Notice that it is possible to completely re-edit the incoming email at the MORECONTENT access point and this serves as the universal access point for all message content.

The SENDLOG access point is where the final form of the message is observed. This access point is primarily for debug purposes, but it is conceivable that the partially transformed message would want to be stored by Organizer.

ENCRYPTION and COMPRESSION access points are where encryption and compression take place. The final form of the message that will travel in the communication channels is sent to RAWOUTPUT. It is possible that some alternate messaging systems cannot connect to the RAWOUTPUT access point to send over that messaging system, eg. faxing compressed data is not a good idea, so the appropriate access point is chosen for each type of alternate messaging system based on that messaging systems' characteristics.

On the receive side, alternate messaging systems have the same issue of what access point to connect to and similar tradeoffs exist as to how complicated the interfacing is that depends on the specific characteristics of the alternate messaging system. Most of the access points on the receive side are simply inverses of the send side, so the appropriate function is self-evident. The one additional access point is the PRERECEIVE access point, which allows for the saving of precious bandwidth on slow connections. The simplest example is detecting that a message is too large and skipping the transferring of the message and instead substituting a notification message that an oversized message was received. Sometimes, the actual message that exists is a notification message itself, so the true size of the message represented by the raw message is used. Then the user is notified that a message that was larger than the specified threshold arrived. The user can decide to just delete it or to download it anyway.

The size of an email is determined from the header information and does not require downloading the entire message. Most POP servers allow the first part of an email to be downloaded, so the PRERECEIVE Transformers have access to all the relevant portions of the email, other than the actual content of any attachments and any email body that exceeds the threshold of what the PRERECEIVE handling is configured to. The transformer Defender protects against a new class of viruses that propagation via email disguised as benign files, such at .TXT files. People who are somewhat technically knowledgable would know that it is not possible for a virus to be infectuous within a TXT file, since a TXT file does not invoke any program to run, which is the basic requirement for virus infection. However, the commonly available email clients default behavior is to display an email attachment file of the form <NAME>.TXT.EXE to appear as “<NAME>.TXT” This means that by clicking on what appears to be a TXT file, the user is actually clicking on an executable EXE file. It also turns out that there are a LOT of filetypes that are in fact exectutable filetypes, eg. “.PIF”, “.COM”, “.BAT” and depending on the software on a person's computer, even word processing documents can have executable code within them, since word processors now have powerful built in macro processing, which in turn can run the virus infection code. This means that <NANIE>.TXT.DOC could represent an infectuous file. In fact <NAME>.DOC would also be potentially infectuous and ultimately, it is possible that a valid email that has executable macros in it is legitimately being sent, so some users will want to have the option to download a message that has the potential to be infectuous, especially if it is an expected document.

As each specific virus is discovered, a specific test for the virus is added to Defender as a specific detector, so the general heuristic is used as a backstop to detect potential viruses, but if Defender is certain that an email is a virus, it can proactively delete it from the server. Alternatively, the user configures the setup to have the option of receiving notification that a potential virus arrived and to manually delete it, or even download it. In some embodiments there is a also a single command accessible to the user to delete all potential viruses that have not been deleted yet.

Of significance is that detection of a potential virus is done without downloading the whole message. This is very important because the bulk of the damage caused by email viruses are due to the bandwidth that they consume just by being sent from machine to machine. Even if it does not infect a machine, it still causes damage due to wasted bandwidth and lost time. By having Defender connect to the PRERECEIVE access point (FIRST), it converts the emails that contain large attachments and viruses to a notification message. A virus that is not downloaded cannot infect a machine, so not only is infection prevented, wasted bandwidth and lost time is prevented.

Another nuisance that Defender protects against is unwanted bulk emails, commonly known as spam. A lot of times the same spam is sent many times to the same recipient with only minor changes. Even if it is not spam, if an email is identical to ones received before, then most users would prefer to only get one copy. Defender keeps a checksum of the body of the most recent N emails that have been received and if a email comes in with the same checksum, it can either be compared with the previous email with the same checksum, or simply be assumed to be the identical email and filtered out. Since a lot of the variation in spam is in the email header, by checking for identical email bodies, a lot of duplicates can be detected. However, some spam is sent using a form emailer, which substitutes a few words in each outgoing email. In order to detect very similar emails, standard web page comparison algorithms are used where the frequency of words are stored. Then when an email that is very similar is received, it is compared with the most recent emails that have arrived and if less than a specified number of words are different, it is treated as a duplicate. Also, when a duplicate is identified, that message is bumped to the front of the list to keep it as an active email that Defender is defending against.

Defender also prevents unauthorized programs from sending emails on a system. This is the primary propagation method that email viruses use, so by blocking the sending of emails, even an infected machine can have all the symptoms of infection treated. Whenever an email is detect as being sent from a program that is not on the list of APPROVED email senders, it is displayed to the user as and UNKNOWN email sender. The user can then categorize that sender as APPROVED or BANNED or to keep it as an UNKNOWN. The specific email can then be sent or blocked depending on whether it was APPROVED or BANNED. It is also possible for the user to configure to not have to specify what to do with UNKNOWN senders and to automatically ban them.

Web-Mail Embodiment:

Sending email from a web based account: For web based email accounts interception and formatting is done transparent to the end user. A module referred to herein as web_facade implements the transparency. To intercept email, but make it appear to the user to be like normal web-based email, the interception program (Veloz as referred to herein) takes over the http transactions on the user's machine. When the user clicks compose (or reply), the transaction does not go through to their mail provider (e.g., yahoo). Instead the transformed content is provided transparent to the user/browser. This goes further than just supplying a static web page since the aforementioned attachment making process requires dynamic content. The easiest way to deal with this is to do the next closest thing to static content—use html templates. These are normal html files with special placeholder fields which web_facade replaces with variable values. These correspond to the hidden and visible html form fields. Multiple templates are used, each template containing all the variables (though some may be hidden) so that a repetitive post method works properly. When the user adds an attachment, a variable for the filename of the attachment is set in the post, and web_facade appends the filename to a growing list of attachment names stored in a different (hidden) variable. The user eventually hits send, which triggers viewing another page generated from a completion template. The completion template in some embodiments is a redirect to the email listing page of the user's particular service. “Send” is the final post which triggers the finished email to be sent. That is the point where veloz.exe is called.

Receiving e-mail over a web-based email service: The web_facade module also handles receiving veloz emails for a web-based service. The recipient receives a veloz email with a ‘.VLZ’ attachment. The user clicks on the attachment, then the attachment opens up in the associated MIME application. Unfortunately this alone would not work because of a special http header (Content-Disposition: attachment) that tells the browser to bring up a ‘Save As’ dialog. As a solution, web_facade being responsible for the http interception, filters the header out (but only for .VLZ attachments and only from specific URLs), allowing the attachment to be opened.

Web_{—facade:}

There are logically three components of web_facade: (1) A snooping http proxy, (2) A system of filters, and (3) Dynamic content using templates. The snooping proxy is implemented from modifying Webcelerator's proxy. A few changes are made so that on each request, the proxy queries the filter component, asking if it's interested in filtering the request. If it's not, then the resource is fetched as normal.

The filter component is bale to modify the request/response in several ways Performance is also a major concern, primarily in that the response time isn't any slower on requests, which aren't filtered. The filter has three functions:

bool processRequestAndDetermineIfBlocks( );

bool mustChangeResponse(string& headers);

void processResponse( );

Before any of these functions are called, each http request a PluginSet object is created and initialized with a data structure that lets it see the current http transaction. The transaction structure isn't completely filled in when this pointer is passed to the object, but the plugin just holds on to it until it is. This is an instance of the class HttpReqResp (though used as a struct) which existed as part of the proxy before it was modified. First the proxy fills in the request part of HttpReqResp and asks the filter if it's going to block the request from getting sent over the Internet and will therefore be responsible for creating the response content. It does this with the boolprocessRequestAndDetermineifBlocks member function. If the filter isn't interested in blocking, or isn't interested at all, it just returns false. Note that the filter may only be interested in seeing the request, which it does here. In cases it changes the request string in the HttpReqResp, taking out headers or making string substitutions.

If the filter blocks, mustChangeResponse is not called since no response can be retrieved (because the request was blocked). If the filter doesn't block, the proxy makes the request to the Internet and retrieves ONLY the very first chunk of the response. This is done for efficiency, and would be combined with the next function otherwise. The reason is that if the plugin were to require seeing the entire response unconditionally before any data is sent to the browser, we would effectively be disabling streaming content. If you were to download a 100 meg streaming video file, normally you can view it as it downloads.

Calling mustChangeResponse(string& headers), gives the filter just a taste of the response then demands to know if the filter must alter the response. Only then does the proxy keep the response until it's complete, not sending any data to the browser.

ProcessResponse is called once the download is complete. If the response changed, this is where the filter alters it, then the proxy finally gives the altered response back to the browser. Otherwise the browser has been getting sent little pieces (streaming) of the response incrementally.

The filters are all derived from Plugin, and have the same three functions as their interface. PluginSet is also derived from Plugin, and adds the function ‘addPlugin(Plugin *plugin) so plugins may be added to it's internal collection. The PluginSet iterates through it's Plugin collection to appropriately handle the three common Plugin functions. On ProcessRequestAndDetermineIfBlocks, it asks each plugin, in the order they were added, if they block. Each Plugin may alter the request before the next Plugin sees it. If one blocks, the remaining plugins are ignored and the PluginSet responds that IT blocks. Similarly, when mustChangeResponse is called (which means none of the plugins blocked), this function is called for each plugin, and if any return true, PluginSet returns true, and streaming is disabled for this request. Once ProcessRequest is called, ProcessRequest is called for each plugin in the collection in reverse. So if none block, ProcessRequest is first called on the last filter. If one blocks, the iteration starts with it. None of the plugins after the blocked one get any of their three functions called.

Plugin Filters

1) Filter out “Content-Disposition: Attachment” header—To let the user click the attachment and have it open up in a .VLZ viewer, the Content-Disposition header is removed.

2) Redirecting—A user on, for example, yahoo mail will be able to interact with yahoo normally until they click to compose a message. At this point, the interaction is intercepted with the user instead working with web-facade. This is handled by a template system but in order to get it there the user is redirected to another web site (e.g., http://www.eacceleration.com/webmail). The reason for redirecting rather than just altering the html content is twofold. It makes it so yahoo can't complain that we're ‘changing’ their content.

The Template handling filter is responsible for producing dynamic content. This carries variables using the subsequent post method and chooses which template to use based on which service the user is on and which stage (e.g., compose page, making an attachment, redirecting back to the web service).

There are two major challenges when considering how the redirect filter will transition to the first template-based page. Both relate to how variables will be passed. The first is the issue of the cookie and compose_url (the URL they are being redirected from). After a user is directed from the yahoo domain, his browser will no longer be sending yahoo's cookies. The cookies will be sent to the compose page that we are intercepting though, so that variable is passed to the template stage in a different way. This is compounded with the second major challenge—dealing with a user replying which means many more variables (to, from, cc, etc) are to be transferred. Also note that the reply variables are to be retrieved in a service specific way. When reply is clicked using a web service, the reply info may be carried on to the compose page in one of two ways: (1) The variables of the email being replied to are posted to the compose cgi; (2) The email identifier is posted or sent as a ? parameter to the compose cgi, and it does an internal lookup of that information.

The redirection filter therefore detects and distinguishes between a compose and reply for each service, and if it's a reply it fetches the email variables (to, body, cc. etc). The asynchronous nature of the redirect makes passing all this data (compose_{—url+cookie+service+reply data if it's a reply) a bit inconvenient but in one embodiment the data is saved to a file and the redirect is given a ?redirect parameter telling it to load the data from the file.}

Template Handling: The actual templates are normal html files with special fields for substituting variables in. For example, if the string ‘----------TO----------’ appears, it is substituted with ‘sonic@eAcceleration.com, “Billy Bob”<billybob@hotmail.com>’. It may even be substituted with a blank string if that's what the value of the variable is. These variables are retained through subsequent posts, so if there's an attachment page separate from the compose page, many of the variables are retained as hidden html variables which are to be reposted. There may be any number of templates for each service. In a preferred embodiment a ‘compose’ template and a ‘done’ template are preent.

Web_send:

Web_send is implemented in a dll as a sendWebMail function. The sendWebMail function will branch differently based off the WEBSERVICE header where it will use the other two headers. It makes several posts, basically emulating the web transactions a human user makes to compose the message, including making the optional SINGLE attachment if the file <filename> has an attachment.

At the point web_send is called, the user has already created an email file which was transformed. All the normal ftp and http interactions have been made except the email hasn't been sent. First, all the fields of the email are parsed, including the three special headers, to, cc, bcc, subject, body, and attachments. An Email class with a loadFromFile(filename) function contains a list of email headers, a list of attachments (though only 0 or 1 are supported), and a list of strings for each the to, cc, and bcc. The subject and the body are simple strings.

To proceed, it is determined which email service to go through, since the transactions to send an email are specific to the web service. This service string (e.g. YAHOO) is stored in the email headers; so I call a function Email::getService to retrieve this string, then create a polymorphic WebService class with a single function ‘send(Email)’. This WebService class is a virtual class; the instance actually used will be any of the supported services (e.g., Yahoo Service, Hotmail Service, or another service). This technique allows for an open-ended design, so that adding services will require only:

1) A change to the function, which creates WebService instances based on the service name (which is basically just a table lookup with knowledge of every specific implement class for each service name)

2) The addition of another WebService class, primarily its send function.

Support for Yahoo service:

There are 4 steps, 2 of which are optional depending on if we send an attachment of not:

Get Compose page;

If (we're sending an attachment)

{

Get Make Attachment Page;

Post (send) Attachment}

}

Post Email

Throughout this process, a common http header is used:

Proxy-Connection: Keep-Alive

User-Agent: Mozilla/4.0 (compatible; MSIE 5.5; Windows 98; Win 9x 4.90)

Accept: image/gif, image/x-xbitmap, image/jpeg, image/pjpeg, image/png, */*

Accept-Language: en

Accept-Charset: iso-8859-1,*,utf-8

Host: <the host of the url we are we are making requests to >

Cookie: <the cookie that was passed in the email headers>

Whenever a POST is made the Content-Length header is set to the size of the post content. This is the only part of the header that changes (or is not present in the case of GETs) throughout this process.

The first transaction, a request for the compose page is made using the above headers. Since the url to the compose page may vary throughout the day, it is not hard coded in the Yahoo Service implementation. Instead it is retrieved from the email (as in the Class Email) headers (it's one of my three special headers). Two strings are parsed from the compose page, referred to herein as ‘crumb’ and ‘yysend.’ There are other variables like these referred to herein as ‘parsed service variables.’

The 4 functions, which correspond to the 4 steps, are private functions as are all functions, which are WebService specific. Send is the only public function. These functions take as arguments, the http header described above, parsed service variables which are needed for the transaction, and reference ‘out parameters’ which will be set to different parsed service variables that are retrieved this transaction (parsed out of the reply) and will be used in a following transaction. The 4 functions are listed below:

1. void Yahoo Service::_get_compose(HTTP_Header &header, string &compose_url, string &yy_send, string &crumb);

This function makes a get request to the compose url and parses out the two variables yy_send and crumb using regular expressions. Here are the regular expressions used for each variable:

yy_send: <form name=“Compose” id=“Compose” method=post

action=“/ym/Compose\?YY=([0-9]+)”>

crumb: <input type=hidden name=“\.crumb” value=“([ˆ ”]+)”>

2. void YahooService::_make_attachments(string &host, HTTP_Header &header ,string& yy_send)

This function makes a get request to

“http://<host>/ym/Attachments?YY=<yy_send>”

No variables are parsed from the return content, but regular expressions are used to make sure that valid content is retrieved. Also, this request is made to simulate user interaction. Also note that the host variable is parsed out of compose_url.

3. void YahooService::_send_attachment(string& host, HTTP_Header& header, Attachment& attachment, string& yy_att, string& out_g_atts, string& out_att_token)

This function POSTs (uploads) an attachment. Typically a post from an html form sends variables in a URL encoded form of key 1=valuel&key2=value2& . . . (Content-Type: application/x-www-form-urlencoded) but an alternate form is multipart which is more suitable for large posts (since it allows binary data) and both yahoo and hotmail use it for uploading attachments. So instead the following header is used:

Content-Type: multipart/form-data; boundary=-----------------------------2239242952023845176537453989

The digits are arbitrary and are used to separate the fields. A sample follows:

Content-Disposition: form-data; name=\“bocd pro x\”r\n\

\r\n\

\r\n\

-----------------------------2239242952023845176537453989\r\n\

Content-Disposition: form-data; name=\“DMid\”\r\n\

\r\n\

\r\n\

. . .

Most the values are blank, but one of these fields includes the filename and the binary data of the file being uploaded. The response is parsed for two service variable, which are listed as out parameters in the function signature. Their names are corresponding regular expressions follow:

g_atts: window\.opener\.RecordAttachments\(“([ˆ “]*)”

att_token: window\.opener\.RecordAttachments\(“[ˆ “]*”, “([ˆ “]+)”

4. void YahooService::_post_mail(string& host, HTTP_Header& header, string& yysend, string& crumb, string& att_token, string& to_list, string& subject, string& cc_list, string& bcc_list, string& body, string& atts)

This function has a lot of parameters, though most of them are self-explanatory. This is just all the email information plus parsed service variables are POSTed and the email is finally sent. The URL posted to is

http://<host>/ym/Compose?YY=<yysend>. The POSTed content is just all these variables plugged into key, value pairs. Constructing the body . . . string postbody;

postbody.append(“.crumb=”);

postbody.append(crumb);

postbody.append(“&box=&FwdFile=&FwdMsg=&FwdSubj=&InReplyT o=&File0Data=”);

postbody.append(att_token);

postbody.append(“&File1Data=&File2Data=&FName=&SEND=Send&To=”);

postbody.append(to list);

postbody.append(“&Subj=”);

postbody.append(subject);

postbody.append(“&Cc=”);

postbody.append(cc_list);

postbody.append(“&Bcc=”);

postbody.append(bcc_list);

postbody.append(“&Body=”);

postbody.append(body);

postbody.append “&Format=&Atts=”);

postbody.append(atts);

Message Transforming Overview

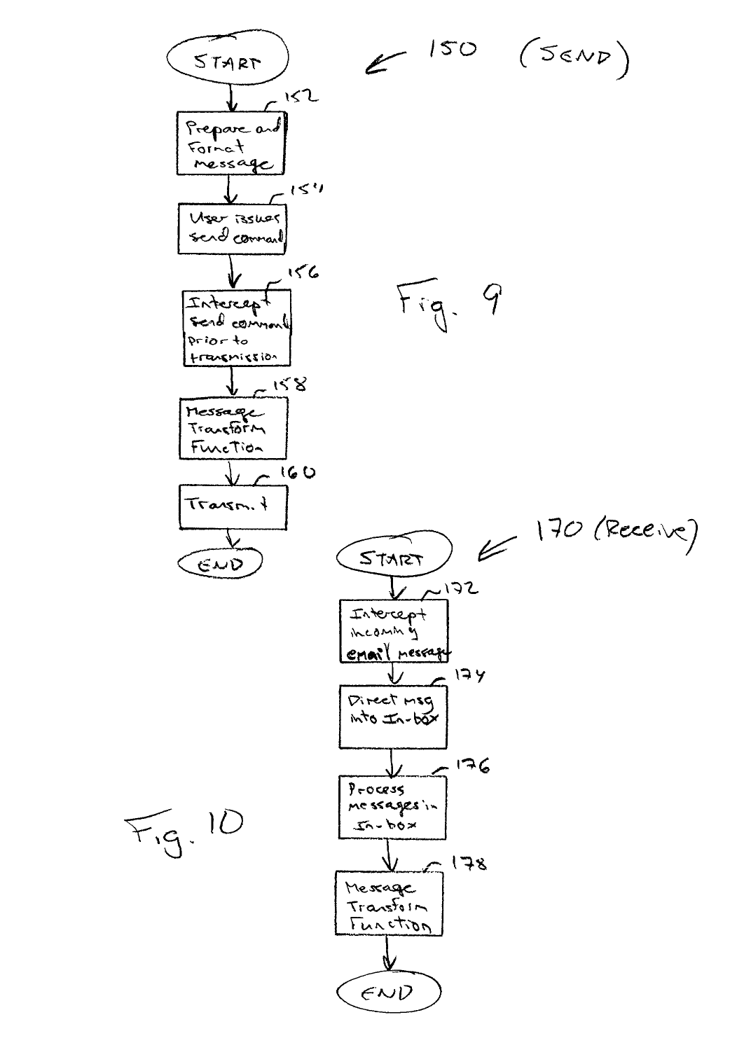

Referring to FIG. 9, a flow chart of a process 150 for sending transformed messages from a client computer onto a wide area network is shown. At step 152, a user prepares and formats a message into at least a header portion and a body portion to achieve a prepared message. At step 154 the user issues a command to send the prepared message. At step 156, the veloz software intercepts the command at the user's computer prior to transmitting the prepared message over the wide area network. At step 158, an operation is performed on the prepared message to achieve the transformed message. At step 160 the transformed message is transmitted over the wide area network.

An exemplary operation to transform the message includes encrypting the prepared message. Another exemplary operation is to perform virus detection by testing whether the prepared message has been generated by an authorized program of the client computer; and preventing transmission when the prepared message is generated by an unauthorized program. Still another exemplary operation is to transform the message protocol, such as from web-based email to another standard email protocol. Yet another exemplary operation is to implement a prescribed viewing format onto the prepared message.

Referring to FIG. 10, a flow chart of a process 170 for receiving transformed messages at a client computer from the wide area network is shown. At step 172, the incoming message is intercepted at the client computer. At step 174, the incoming message is directed into a common in-box for messages of varying protocols. At step 176, messages in the in-box are processed prior to viewing by a user. Specific access points are available during the step of processing to perform specific operations on the message being processed. Exemplary operations include virus detection and decryption. At step 178 the incoming message in the in-box being processed is acessed and transformed the incoming message from a first protocol used for sending the message into a different protocol.

In an embodiment where virus detection is performed handling of the incoming message is determined according to a result of the virus testing. When a virus is not detected, the incoming message is idrected into the common in-box for messages of varying protocols. Messages in the in box are processed prior to viewing by a user, wherein specific access points are available during the step of processing to perform specific operations on the message being processed. A hierarchy of access points and corresponding operations are performed, including an access point for a decryption operation, and access point for a viewer design operation and an access point for organizing incoming messages into a log.

Although a preferred embodiment of the invention has been illustrated and described, various alternatives, modifications and equivalents may be used. Therefore, the foregoing description should not be taken as limiting the scope of the inventions which are defined by the appended claims.

What is claimed is:

1. A method for message handling over a wide area network, the wide area network including a first computer, a second computer and a key server computer, wherein there is a first address associated with the first computer and a second address associated with the second computer, the method comprising the steps of:
maintaining a key repository of public keys for a plurality of users on the key server computer;
generating a message by a first user for a second user addressed to the second computer;
accessing with the first computer the key repository on the key server computer to determine whether there is a public key associated with the second computer address stored in the key repository;
when there is a public key associated with the second computer address stored in the key repository, downloading said associated public key to the first computer;
encrypting the generated message using the downloaded public key; and
transmitting the encrypted message from the first computer to the second computer.

2. The method of claim 1, wherein the generated message is a first message, and further comprising the steps of:
storing the dowloaded public key on the first computer, along with a timestamp and the associated second computer address;
generating a second message by the first user for the second user addressed to the second computer;
encrypting the generated second message using the public key associated with the second computer address stored on the first computer; and
transmitting the encrypted second message from the first computer to the second computer.

3. The method of claim 1, further comprising the steps of:
generating a private key and a corresponding public key for the second user on the second computer;
uploading the corresponding public key into the key repository of the key server computer, wherein the steps of generating the private key and uploading the corresponding public key are performed prior to the step of downloading;
receiving at the second computer the encrypted message transmitted from the first computer;
decrypting the encrypted message using the private key.

4. The method of claim 3, further comprising the steps of:
reading a public key associated with a first user which is included with the encrypted first message;
storing the public key associated with the first user on the second computer;
encrypting a second message using the public key associated with the first user; and
transmitting the encrypted second message from the second computer to the first computer.

5. The method of claim 3, further comprising the steps of:
transmitting from the second computer to the key server computer a request that a token be sent back to the second computer at a second user address;
generating and storing the token on the key server computer, wherein the token is associated with the second user address;
sending the token to the second user address;
receiving the token at the second computer; and
wherein the step of uploading comprises the steps of:
transmitting from the second computer to the key server computer a request to add the public key of the second user into the key repository, wherein included with the request to add the second user's public key is the token;
verifying that the token received at the key server computer is the same as the token stored for the second user address; and
when the token is successfully verified as being the token stored for the second user address, storing the requested public key into the key repository.

6. The method of claim 1, further comprising the steps of:
determining whether there is a private key and corresponding public key for the first user stored locally on the first computer;
when either one or both of the private key and corresponding public key are not stored locally on the first computer, determining whether the first user has a first user address in use on another computer;
when the first user does not have the first user address in use on another computer, generating a private key and a corresponding public key associated with the first user address.

7. The method of claim 6, further comprising the steps of:
when the first user does have the first user address in use on another computer, instructing the first user to download the private key and corresponding public key from said other computer to the first computer.

8. The method of claim 3, further comprising the steps of:
receiving at the second computer the encrypted message transmitted from the first computer;
unsuccessfully decrypting the encrypted message at the second computer;
determining whether there is a valid key pair of a private key and a corresponding public on the second machine for the second user address, wherein the step of determining comprises:
transmitting key data from the second computer to the key server; and
evaluating the key data at the key server to determine whether there is a valid key pair.

9. The method of claim 8, further comprising the steps of:
when there is not a valid key pair on the second computer, downloading the valid key pair for the second user from another computer onto the second computer.

10. The method of claim 8, further comprising the steps of:
when there is not a valid key pair on the second computer, generating a new key pair including a private key and a corresponding public key for the second user;
uploading the corresponding public key of the second user into the key repository of the key server computer;
sending a message to the first user at the first computer, including the public key of the second user generated as part of the new key pair;
re-encrypting the generated message using the new public key of the second user;
transmitting the re-encrypted message from the first computer to the second computer.
receiving at the second computer the re-encrypted message transmitted from the first computer;
decrypting the re-encrypted message using the private key from the new key pair.

11. A method for message handling over a wide area network, the wide are network including a first computer, a second computer and a key server computer, wherein there is a first address associated with the first computer and a second address associated with the second computer, the method comprising the steps of:
generating a private key and a corresponding public key for a first user on the first computer, wherein said corresponding public key is used for encrypting messages intended to be received by the first user, and wherein the private key is used for decrypting messages which have been encrypted using the corresponding public key;
transmitting from the first computer to the key server computer a request that a token be sent back to the first computer at a first user address;
generating and storing the token on the key server computer, wherein the token is associated with the first user address;
sending the token to the first user address;
receiving the token at the first computer;
transmitting from the first computer to the key server computer a request to add the public key of the first user into a key repository maintained by the key server computer, wherein included with the request to add the public key is the token;
verifying that the token received at the key server computer is the same as the token stored for the first user address; and
when the token is successfully verified as being the token stored for the first user address, storing the requested public key into the key repository.

12. A message handling system, comprising:
a message services server, comprising a key repository database and a subscriber request processor, wherein the key repository comprises public keys for a plurality of users having corresponding user addresses;
a plurality of computers wherein each one computer of the plurality of computers has access to other computers of the plurality of computers and to the message services server, each one computer of the plurality of computers comprising: a key database and a message processor for handling secure messages;
wherein the subscriber request processor responds to requests from the plurality of computers, the requests comprising a lookup request, an upload request and a token request;
the lookup request being to find a public key in the key repository associated with a specific user address;
an upload request being to upload a public key associated with a user address from the requesting computer of the plurality of computers into the key repository; and
a token request being to have the message services server transmit a token to a requesting computer of the plurality of computers, the token used by the requesting computer during a subsequent upload request to validate sad subsequent request.

13. The message handling system of claim 12, wherein the message processor for a receiving computer of the plurality of computers,
generates a private key and a corresponding public key for a recipient user on the receiving computer;
uploads the corresponding public key into the key repository;
receives an encrypted message transmitted from a sending computer;
decrypting the encrypted message using the private key.

14. The system of claim 13, wherein the message processor for the receiving computer of the plurality of computers,
reads a public key associated with a sender user which is included with the encrypted message;
stores the public key associated with the first user in the key database of the receiving computer; and
encrypts a second message using the public key associated with the first user.

15. The message handling system of claim 12, wherein the message processor for a sending computer of the plurality of computers,
accesses the key repository to determine whether there is a public key associated with a recipient address stored in the key repository;
when there is a public key associated with the recipient address stored in the key repository, downloading said associated public key to the sending computer;
storing the downloaded public key in the key database of the sending computer; and
encrypting the generated message using the downloaded public key.

16. The system of claim 13, wherein each one computer of the plurality of computers comprises:
means for determining whether there is a valid key pair of a private key and a corresponding public on said one computer for a specific user address.

17. A method for sending messages from a client computer onto a wide area network, comprising the steps of:
formatting a message into at least a header portion and a body portion to achieve a prepared message;
receiving a user command to send the prepared message;
intercepting at a client computer the prepared message prior to transmitting the prepared message over a wide area network;
performing an operation on the prepared message to achieve a transformed message; and
transmitting the transformed message over the wide area network.

18. The method of claim 17, in which the step of performing comprises: implementing a prescribed viewing format onto the prepared message.

19. The method of claim 17, in which the step of performing comprises: encrypting the prepared message.

20. The method of claim 17, in which the step of performing comprises: testing whether the prepared message has been generated by an authorized program of the client computer; and preventing transmission when the prepared message is generated by an unauthorized program.

21. The method of claim 17, in which the step of performing comprises transforming a message handling protocol of the prepared message.

22. A method for handling incoming messages to a client computer from a wide area network, comprising the steps of:
intercepting an incoming message;
directing the incoming message into a common in-box for messages of varying protocols;
processing messages in the in-box prior to viewing by a user, wherein specific access points are available during the step of processing to perform specific operations on the message being processed;
accessing the incoming message in the in-box being processed and transforming the incoming message from a first protocol used for sending the message into a different protocol.

23. The method of claim 22, wherein the first protocol is a first e-mail protocol and the different protocol is one protocol from the group of protocols including: voice mail protocol and a second e-mail protocol.

24. A method for handling incoming messages to a client computer from a wide area network, comprising the steps of:
intercepting an incoming message prior to being fully received;
testing the incoming message for presence of a virus;
determining handling of the incoming message according to a result of the testing step;
when a virus is not detected, directing the incoming message into a common in box for messages of varying protocols;
processing messages in the in box prior to viewing by a user, wherein specific access points are available during the step of processing to perform specific operations on the message being processed.

25. The method of claim 24 in which a hierarchy of access points and corresponding operations are performed, including an access point for a decryption operation, and access point for a viewer design operation and an access point for organizing incoming messages into a log.
